(19) United States
(12) Patent Application Publication
(10) Pub. No.: US 2021/0340802 A1
(43) Pub. Date: Nov. 4, 2021

(54) STRUCTURE CAPABLE OF PRE-SETTING LONG AND SHORT SELF-POSITIONING TIME POINTS TO ENABLE HINGE LEAVES TO CLOSE BY THEMSELVES

(71) Applicant: Shandong Meiyi Automation Technology Co., Ltd., Liaocheny City, Shandong Province (CN)

(72) Inventor: Yulung WU, Xiamen City, Fujian (CN)

(21) Appl. No.: 17/263,377

(22) PCT Filed: Oct. 10, 2017
(86) PCT No.: PCT/CN2017/105523

§ 371 Date: Jul. 16, 2021

(30) Foreign Application Priority Data
Oct. 10, 2016 (CN) 201610883060.1

(51) Int. Cl. E05F 1/00; E05D 7/00; B60R 16/03

(52) U.S. Cl. CPC E05F 1/008; E05D 7/00; B60R 16/03; E05Y 2900/531; E05Y 2201/462; E05Y 2400/44; E05Y 2400/61; E05Y 2201/696

(57) ABSTRACT

The present disclosure provides a structure configured to preset an automatic positioning duration to enable hinge blades to be automatically closed, the structure two hinge blades, a threaded sleeve, a fixed rod, a first spring, a electromagnet suction disk, a DC power supply electromagnet, a DC power supply timing controller, a remote control, a plug, and an adjusting base. The two hinge blades are configured to rotate relative to each other, each of the two hinge blades comprises a shaft sleeve and a blade fixed on an outer side of the shaft sleeve, the fixed rod comprises a threaded rod, the threaded sleeve comprises a transmission rod fixed in the shaft sleeve of the two hinge blades, the plug is fixedly disposed in the shaft sleeve of the two hinge blades, the threaded sleeve is separated from the plug, and the fixed rod, the first spring, the electromagnet suction disk, the power supply electromagnet, a bearing, and the adjusting base are disposed between the threaded sleeve and the plug disposed in the shaft sleeve of the two hinge blades. When the hinge blades reach the automatic positioning time preset by the timing controller, so that the hinge blades synchronously cooperates with the demagnetization time point preset by the timing controller. At the same time, the elastic force energy storage of the first spring changes and releases. An application of the present disclosure is wide, and has good industrial applicability.

### FIELD OF THE DISCLOSURE

The present disclosure relates to a structure configured to preset an automatic positioning duration to enable hinge blades to be automatically closed.

### BACKGROUND OF THE DISCLOSURE

The patent number 201320835655.1 in the Chinese patent database discloses a liftable hinge blade device, which comprises an upper hinge blade, a lower hinge blade, a transmission base, and a transmission rod. The upper hinge blade comprises an upper shaft sleeve and a blade of the upper hinge blade fixed on the upper shaft sleeve. The lower hinge blade comprises a lower shaft sleeve and a blade of the lower hinge blade fixed on the lower shaft sleeve. The transmission base is fixed on the upper shaft sleeve. A bottom end surface of the transmission base is concave to define a transmission cavity, and an inner rotating surface of the transmission cavity is disposed with a first spiral part. The transmission base is fixed on the lower shaft sleeve, and an outer rotating surface of the transmission rod is disposed with a second spiral part. The transmission rod is connected to the transmission cavity, and the first spiral part cooperates with and is engaged with the second spiral part. The upper hinge blade is pushed to enable the upper hinge blade to rotate relative to the lower hinge blade, and the first spiral part cooperates with the second spiral part to enable the upper hinge blade to move upward. The pushing of the upper hinge blade is stopped to enable the upper hinge blade to descend by gravity, and the first spiral part cooperates with the second spiral part to enable the upper hinge blade to be automatically reset to be closed. The liftable hinge blade device cannot achieve an automatic positioning at a preset positioning angle, an automatic close within the preset positioning angle, adjusting a preset angle of the automatic positioning, presetting an automatic positioning time, and enabling the hinge blades themselves to be automatically closed.

### BRIEF SUMMARY OF THE DISCLOSURE

In order to overcome deficiencies of the liftable hinge blade device of the existing techniques, the present disclosure provides a structure configured to preset an automatic positioning duration to enable hinge blades to be automatically closed.

In order to solve the technical problems, a first technical solution of the present disclosure is as follows.

A structure configured to preset an automatic positioning duration to enable hinge blades to be automatically closed comprises two hinge blades, a threaded sleeve, a fixed rod, a first spring, an electromagnet suction disk, a power supply electromagnet, a power supply timing controller, a plug, and an adjusting base. The two hinge blades are configured to rotate relative to each other, each of the two hinge blades comprises a shaft sleeve and a blade fixed on an outer side of the shaft sleeve, the fixed rod comprises a threaded rod, the threaded sleeve comprises a transmission rod, the transmission rod is fixed in the shaft sleeve of the two hinge blades, the plug is fixedly disposed in the shaft sleeve of the two hinge blades, the threaded sleeve is separated from the plug, the fixed rod, the first spring, the electromagnet suction disk, the power supply electromagnet, a bearing, and the adjusting base are disposed between the threaded sleeve and the plug disposed in the shaft sleeve of the two hinge blades, the fixed rod cooperates with and is screwed to the threaded sleeve, the adjusting base is adjusted to rotate to adjust a required distance between the power supply electromagnet and the electromagnet suction disk to enable the power supply electromagnet and the electromagnet suction disk to be positioned on an inner ring of a cup body, the adjusting base is configured to synchronously and correspondingly cooperate to adjust the two hinge blades to be automatically positioned at a required preset positioning angle position, one end of the power supply timing controller is connected to a power supply wire connector of a power supply base, another end of the power supply timing controller is connected to a power supply wire connector of the power supply electromagnet, the power supply timing controller functions by mobile phone remote control, voice control, wireless remote control, electronic intelligence control, or manual control of a preset button for an automatic positioning duration of the power supply timing controller by which the two hinge blades are automatically positioned at the required preset positioning angle position, a duration by which the power supply electromagnet is magnetically coupled to the electromagnet suction disk each time is preset, the power supply timing controller synchronously and correspondingly cooperates to preset an automatic positioning duration by which the two hinge blades are automatically positioned at the required preset positioning angle position each time to enable the two hinge blades to be automatically positioned at the required preset positioning angle position. When the two hinge blades reach a demagnetization time preset by the power supply timing controller at which the power supply electromagnet is magnetically coupled to the electromagnet suction disk, the two hinge blades are configured to synchronously and correspondingly cooperate with the demagnetization time of the power supply electromagnet, an energy storage of the first spring changes and releases to enable an elastic force energy storage of one end of the first spring to abut a convex ring and another end of the first spring to abut a gasket of a front plane of the cup body, the two hinge blades rotates to close a door blade.

In order to solve the technical problems, a second technical solution of the present disclosure is as follows.

A structure configured to preset an automatic positioning duration to enable hinge blades to be automatically closed comprises two hinge blades, a connecting sleeve, a threaded sleeve, a fixed rod, a first spring, an electromagnet suction disk, a 12 volt DC power supply electromagnet, a 220 volt AC power supply transformer for converting a 12 volt DC power supply, a 12 volt DC power supply timing controller, a wireless remote control, a plug, and an adjusting base. The two hinge blades are configured to rotate relative to each other, each of the two hinge blades comprises a shaft sleeve and a blade fixed on an outer side of the shaft sleeve, the fixed rod comprises a threaded rod, the connecting sleeve is encompassed in the shaft sleeve of the two hinge blades, the threaded sleeve is rotatably and not movably disposed in one end of the connecting sleeve, the plug is fixedly disposed in another end of the connecting sleeve, the threaded sleeve is separated from the plug, the fixed rod, the first spring, the electromagnet suction disk, the 12 volt DC power supply electromagnet, a bearing, and the adjusting base are disposed between the threaded sleeve and the plug disposed in the connecting sleeve, convex threaded teeth of two or more of six reverse straight oblique pitches of the threaded rod of the fixed rod cooperate with and are screwed to concave threaded teeth of two or more of six reverse straight oblique pitches of the threaded rod of the fixed rod, the adjusting base is adjusted to rotate to cooperate with the plug, the fixed rod of the 12 volt DC power supply electromagnet, a cup bottom of a cup body, and the 12 volt DC power supply electromagnet and to adjust a required distance between the 12 volt DC power supply electromagnet and the electromagnet suction disk to enable the 12 volt DC power supply electromagnet and the electromagnet suction disk to be positioned on an inner ring of the cup body, the adjusting base is configured to synchronously and correspondingly cooperate to adjust the two hinge blades to be automatically positioned at a required preset positioning angle position, the converting comprising: one end input of the 220 volt AC power supply transformer for converting into the 12 volt DC power supply is a 220 volt AC power supply plug, a red wire of the 220 volt AC power supply plug for converting into the 12 volt DC power supply is an electronic live wire and is connected to a first input conversion connector of a 220 volt AC power supply of the 220 volt AC power supply transformer, a blue wire of the 220 volt AC power supply plug for converting into the 12 volt DC power supply is a neutral wire and is connected to a second input conversion connector of the 220 volt AC power supply of the 220 volt AC power supply transformer, the 220 volt AC power supply plug for converting into the 12 volt DC power supply is plugged in a 220 volt AC power supply socket, a first output end of the 220 volt AC power supply transformer for changing into the 12 volt DC power supply is a positive connector converted into the 12 volt DC power supply, a second output end of the 220 volt AC power supply transformer for changing into the 12 volt DC power supply is a negative connector converted into the 12 volt DC power supply, a positive DC power supply connector of the 12 volt DC power supply timing controller is connected to the positive connector converted into the 12 volt DC power supply of the first output end of the 220 volt AC power supply transformer for converting into the 12 volt DC power supply, a negative DC power supply connector of the 12 volt DC power supply timing controller is connected to a negative connector converted into the 12 volt DC power supply of the second output end of the 220 volt AC power supply transformer for converting into the 12 volt DC power supply, a positive wire of the 12 volt DC power supply electromagnet is connected to the positive connector converted into the 12 volt DC power supply of a first output end of the 12 volt DC power supply timing controller, a negative wire of the 12 volt DC power supply electromagnet is connected to one lead wire of a sensor with a lead wire of a door magnetic switch, another lead wire of the sensor with the lead wire of the door magnetic switch is connected to the negative connector converted into the 12 volt DC power supply of a second output end of the 12 volt DC power supply timing controller, the 12 volt DC power supply electromagnet and the electromagnet suction disk are configured to correspondingly cooperate with the 12 volt DC power supply timing controller and the sensor with the lead wire and a magnet body of the door magnetic switch, the 12 volt DC power supply timing controller functions by mobile phone remote control, voice control, wireless remote control, electronic intelligence control, or manual control of a preset button for a hinge blade positioning duration of the 12 volt DC power supply timing controller, a duration by which the 12 volt DC power supply electromagnet and the electromagnet suction disk are fixedly and magnetically coupled each time is preset to also correspondingly define the automatic positioning duration of the two hinge blades that is automatically positioned at the required preset positioning angle position each time. When the two hinge blades reaches an automatic positioning time of the two hinge blades preset by the 12 volt DC power supply timing controller to define a demagnetization time at which the 12 volt DC power supply electromagnet is magnetically coupled to the electromagnet suction disk, the two hinge blades are configured to correspondingly cooperate with the demagnetization time preset by the 12 volt DC power supply timing controller at which the 12 volt DC power supply electromagnet is magnetically coupled with the electromagnet suction disk, an elastic force energy storage of the first spring changes and releases, the elastic force energy storage of one end of the first spring is configured to abut a convex ring, and the elastic force energy storage of another end of the first spring abuts a gasket disposed on a front plane of the cup body, so that the two hinge blades themselves are configured to rotate to close a door blade.

Compared with the existing techniques, the technical solution has the following advantages.

The blades of the hinge blades is pushed to be opened in the left rotation direction, so that the first shaft sleeve of the blades of the hinge blades can drive the transmission rod disposed in the first shaft sleeve and the threaded sleeve disposed in the second sleeve to rotate, the threaded rod of the fixed rod disposed in the second shaft sleeve to axially slide downward to strongly compress the elastic force energy storage of the first spring relative to the threaded sleeve disposed in the second shaft sleeve, the cylinder front surface of the convex ring of the fixed rod is configured to slide downward to strongly compress the elastic force energy storage of the spring, and the elastic force energy storage of another end is configured to strongly abut the gasket of the front plane the cup body. At the same time, a size value of a straight oblique pitch of the convex threaded teeth of two or more of the six forward straight oblique pitches of the threaded rod of the fixed rod cooperates with and is screwed to a size value of a straight oblique pitch of the concave threaded teeth of two or more of the six forward straight oblique pitches of the threaded sleeve. Therefore, the distance that the threaded rod axially moves up and down relative to the threaded sleeve is preset. A releasing of the elastic force energy storage of the spring is configured to be limited, therefore, a speed that the blades of the hinge blades rotate rightward to be automatically closed is synchronously preset, and the threaded rod axially slides up and down relative to the threaded sleeve within the preset angle of the rotation of the hinge blades. the electromagnetic force applied to the fixed rod that the 12 volt DC power supply electromagnet and the electromagnet suction disk are magnetically coupled together counteracts the abutting force of the elastic force energy storage of the first spring, so that the blades of the hinge blades can be automatically positioned at the preset positioning angle of the rotation, which is convenient for using. At the same time, the adjusting base is adjusted to rotate to cooperate with the plug, the fixed connection threaded rod of the electromagnet, the cup bottom of the cup body, and the 12 volt DC power supply electromagnet, the required distance between the 12 volt DC power supply electromagnet and the electromagnet suction disk is configured to be adjusted, the 12 volt DC power supply electromagnet and the electromagnet suction are configured to magnetically coupled together to be positioned in the inner ring of the cup body. At the same time, the adjusting base is configured to synchronically and correspondingly adjust the hinge blades to be automatically positioned at the required preset positioning angle position. At the same time, the 12 volt DC power supply timing controller 125 functions by mobile phone remote control, voice control, wireless remote control, electronic intelligence control, or manual control of the preset button for the automatic positioning duration of the 12 volt DC power supply timing controller that the hinge blades are automatically positioned at the preset positioning angle position. The duration that the 12 volt DC power supply electromagnet and the electromagnet suction disk are coupled together each time is configured to be preset. At the same time, the 12 volt DC power supply timing controller can also synchronically and correspondingly cooperate to preset the automatic duration that the hinge blades are automatically positioned at a preset positioning angle each time to enable the hinge blades to be automatically positioned at the preset positioning angle. When the blades of the hinge blades reach the preset time preset by the 12 volt DC power supply the timing controller that the hinge blades are automatically positioned at the preset positioning angle position to enable the hinge blades to correspond to the demagnetization time point preset by the 12 volt DC power timing controller that the 12 volt DC power supply electromagnet and the electromagnet suction disk are magnetically coupled together, so that the 12 volt DC power supply electromagnet correspondingly cooperates with the demagnetization time point preset by the 12 volt DC power timing controller that the 12 volt DC power electromagnet and the electromagnet suction disk are magnetically coupled together. At the same time, the elastic force energy storage of the first spring changes and releases to enable the elastic force energy storage of the one end of the first spring to abut the cylinder front surface of the convex ring, the elastic force energy storage of another end is configured to strongly abut the gasket on the front plane of the cup body, so that the hinge blades themselves can automatically rotate rightward to be closed. The size value of the straight oblique pitch of the convex threaded teeth of two or more reverse straight oblique pitches of the threaded rod of the fixed rod and a number strip of the convex threaded teeth of the reverse straight oblique pitches cooperates with and is screwed to the size value of the straight oblique pitch of the concave threaded teeth of two or more reverse straight oblique pitches of the threaded sleeve and a number strip of the concave threaded teeth of the reverse straight oblique pitches. Therefore, the blades of hinge blades are pushed to be opened in the rightward rotation direction. The blades of hinge blades are automatically closed in the leftward rotation direction. At the same time, the threaded rod is configured to move and slide downward and upward relative to the threaded sleeve within the preset angle of the rotation of the hinge blades.

### BRIEF DESCRIPTION OF THE DRAWINGS

The present disclosure will be further described below in conjunction with the drawings and embodiments.

FIG. 1 illustrates a perspective sectional-view of a vehicle door hinge of Embodiment 1.

FIG. 1-1 illustrates a perspective view of a second hinge blade of Embodiment 1.

FIG. 1-2 illustrates a perspective view of a first hinge blade of Embodiment 1.

FIG. 1-3 illustrates a perspective view of a threaded sleeve of Embodiment 1.

FIG. 1-4 illustrates a perspective view of a fixed rod of Embodiment 1.

FIG. 1-5 illustrates a perspective view of a fixed sliding rod of Embodiment 1.

FIG. 1-6 illustrates a perspective view of a first bearing of Embodiment 1.

FIG. 1-7 illustrates a perspective view of a sliding rotation sleeve tube of Embodiment 1.

FIG. 1-8 illustrates a perspective view of a first gasket of Embodiment 1.

FIG. 1-9 illustrates a perspective view of a second gasket of Embodiment 1.

FIG. 1-10 illustrates a perspective view of a third gasket of Embodiment 1.

FIG. 1-11 illustrates a perspective view of a 12 volt direct current (DC) power supply electromagnet of Embodiment 1.

FIG. 1-12 illustrates a perspective view of a fixed connection threaded rod of a sleeve cap of Embodiment 1.

FIG. 1-13 illustrates a perspective view of the sleeve cap of Embodiment 1.

FIG. 1-14 illustrates a perspective view of an electromagnet suction disk of Embodiment 1.

FIG. 1-15 illustrates a perspective view of a rubber column of Embodiment 1.

FIG. 1-16 illustrates a perspective view of a plug of Embodiment 1.

FIG. 1-17 illustrates a perspective view of an adjusting base of Embodiment 1.

FIG. 1-18 illustrates a perspective view of a fixed connection threaded rod of the 12 volt DC power supply electromagnet of Embodiment 1.

FIG. 1-19 illustrates a perspective view of a spring of Embodiment 1.

FIG. 1-20 illustrates a perspective view of a 12 volt DC power supply base of a vehicle body of Embodiment 1.

FIG. 1-21 illustrates a perspective view of a 12 volt DC power supply timing controller of Embodiment 1.

FIG. 1-22 illustrates a perspective view of a wireless remote of the 12 volt DC power supply timing controller of Embodiment 1.

FIG. 2 illustrates a perspective sectional-view of a vehicle door hinge of Embodiment 2.

FIG. 3 illustrates a perspective sectional-view of a vehicle door hinge of Embodiment 3.

FIG. 3-1 illustrates a perspective view of a 24 volt DC power supply timing controller of Embodiment 3.

FIG. 3-2 illustrates a perspective view of a DC power supply transformer of Embodiment 3.

FIG. 3-3 illustrates a perspective view of a wireless remote of the 24 volt DC power supply timing controller of Embodiment 3.

FIG. 3-4 illustrates a perspective view of a side through hole of a power supply wire of a cup body of Embodiment 3.

FIG. 3-5 illustrates a perspective view of a sensor with a lead wire of a door magnetic switch of Embodiment 3.

FIG. 3-6 illustrates a perspective view of a magnet body without the lead wire of the door magnetic switch of Embodiment 3.

FIG. 4 illustrates a perspective sectional-view of a hinge of Embodiment 4.

FIG. 4-1 illustrates a perspective view of a second hinge blade of Embodiment 4.

FIG. 4-2 illustrates a perspective view of a first hinge blade of Embodiment 4.

FIG. 4-3 illustrates a perspective view of a swivel ring of Embodiment 4.

FIG. 4-4 illustrates a perspective view of a first bearing of Embodiment 4.

FIG. 4-5 illustrates a perspective view of a threaded ring of Embodiment 4.

FIG. 4-6 illustrates a perspective view of an assembly of a connection sleeve of Embodiment 4.

FIG. 4-7 illustrates a perspective view of a plug of Embodiment 4.

FIG. 4-8 illustrates a perspective view of a threaded sleeve of Embodiment 4.

FIG. 4-9 illustrates a perspective view of a fixed rod of Embodiment 4.

FIG. 4-10 illustrates a perspective view of a sealing rubber ring of Embodiment 4.

FIG. 4-11 illustrates a perspective view of a third bearing of Embodiment 4.

FIG. 4-12 illustrates a perspective view of a 220 volt alternating current (AC) power supply timing controller of Embodiment 4.

FIG. 4-13 illustrates a perspective view of a 220 volt AC power supply transformer of Embodiment 4.

FIG. 5 illustrates a perspective sectional-view of a hinge of Embodiment 5.

FIG. 5-1 illustrates a perspective view of a first hinge blade of Embodiment 5.

FIG. 5-2 illustrates a perspective view of a power supply wire through hole of a side surface of a second shaft sleeve of Embodiment 5.

FIG. 5-3 illustrates a perspective view of a power supply wire through hole of a side surface of a connecting sleeve of Embodiment 5.

### DETAILED DESCRIPTION OF THE EMBODIMENTS

### Embodiment 1

A structure configured to preset an automatic positioning duration to enable hinge blades to be automatically closed is, for example, disposed in shaft sleeves of vehicle door folded hinge blades, vehicle door hinge blades, and carriage door hinge blades defining any shapes, for example, a butterfly hinge, an H-shaped hinge, a son-and-mother shaped hinge, a flag-shaped hinge, etc. A hinge comprising the structure configured to preset the length of self-positioning time to automatically close the hinge blade is, for example, disposed in door blades of an inner door and an outer door, door blades of a door and a window, door blades of a vehicle door, door blades of a carriage door, etc. The hinge is configured be set from a 10-degree positioning angle of a preset positioning angle to a 180-degree positioning angle of the preset positioning angle, and blades of the hinge blades are configured to be automatically positioned at a starting point of any preset angle between the 10-degree positioning angle and a 180-degree positioning angle of the preset positioning angle. When the hinge blades need to be closed, a 12 volt direct current (DC) power supply timing controller 125 functions by mobile phone remote control, voice control, wireless remote control, electronic intelligence control, or manual control of a preset button for an automatic positioning duration of the 12 volt DC power supply timing controller 125 by which the hinge blades are automatically positioned at the preset positioning angle. A duration by which a 12 volt DC power supply electromagnet 80 is magnetically coupled to an electromagnet suction disk 90 each time is preset. At the same time, the 12 volt DC power supply timing controller 125 can also synchronically preset the automatic positioning duration by which the hinge blades are automatically positioned at the preset positioning angle. When the hinge blades reach the automatic positioning time preset by the 12 volt DC power supply timing controller 125, and it is a demagnetization time point by which the 12 volt DC power supply electromagnet 80 and the electromagnet suction disk 90 are magnetically coupled together. At the same time, an elastic force energy storage of a first spring 91 releases, so that the elastic force energy storage of one end of the first spring 91 can strongly abut a cylinder front surface of a convex ring, and the elastic force energy storage of another end can strongly abut a gasket 86 disposed on a front plane of a cup body 56. Therefore, the first spring 91 enables a first blade of a first hinge blade to rotate backward to be closed, and door hinges themselves are closed in a rightward rotation direction.

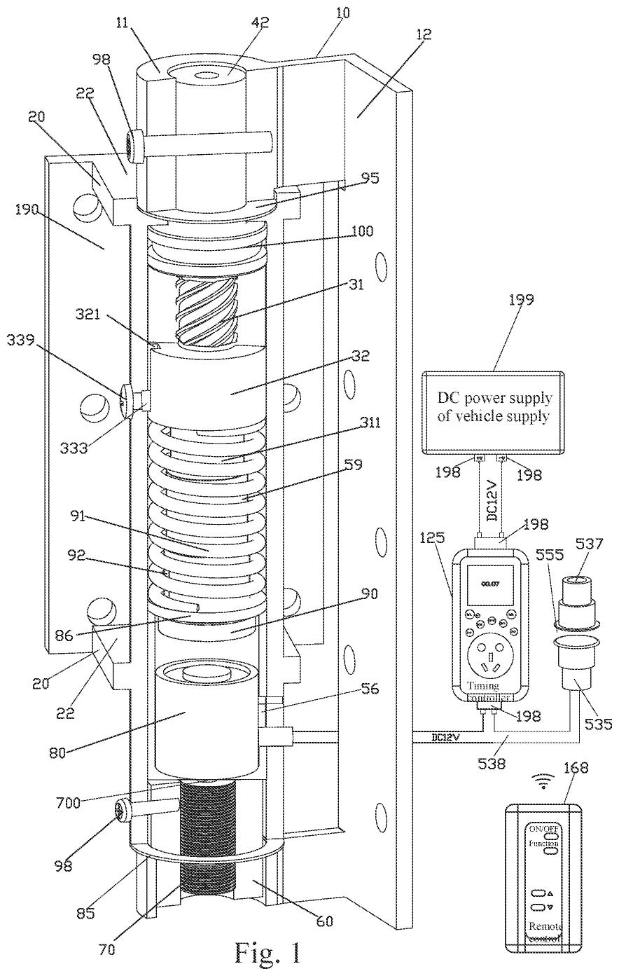

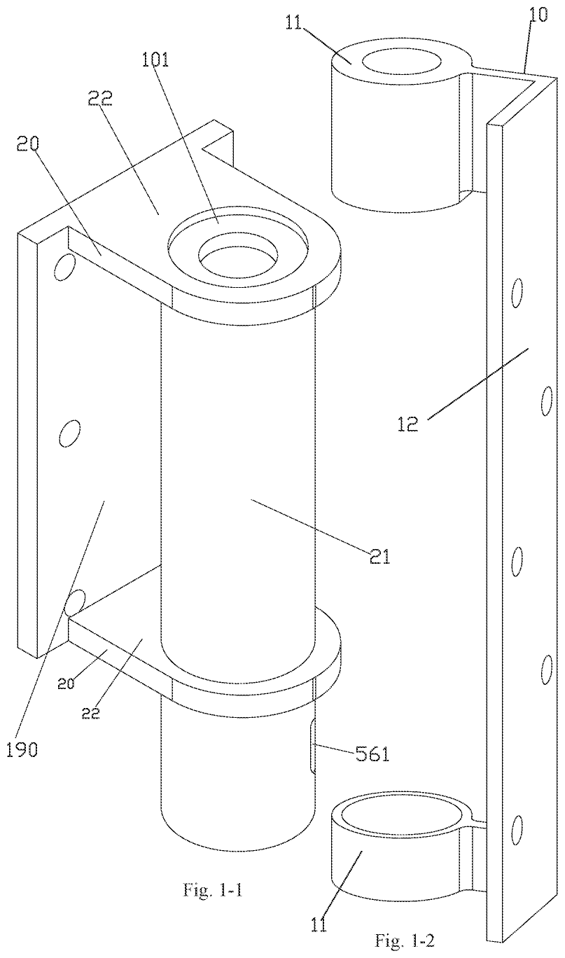

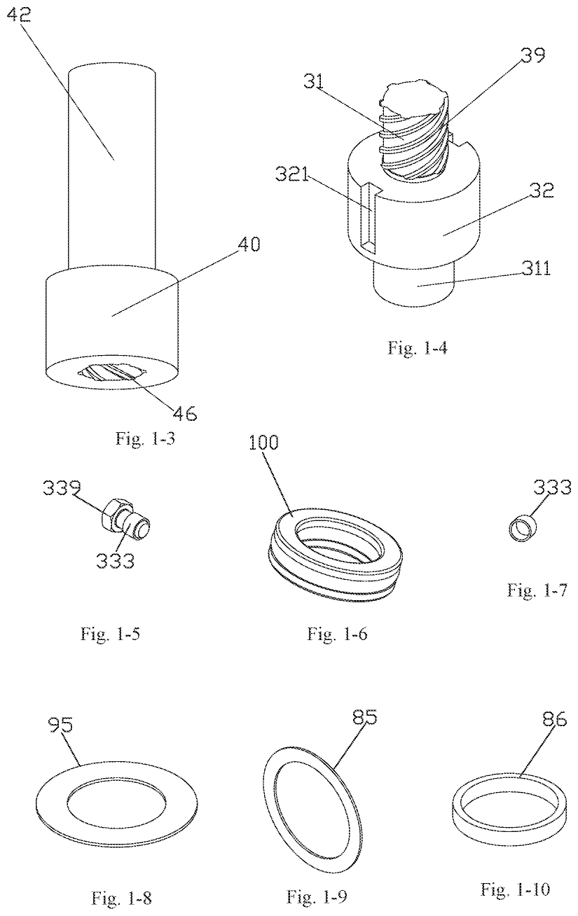

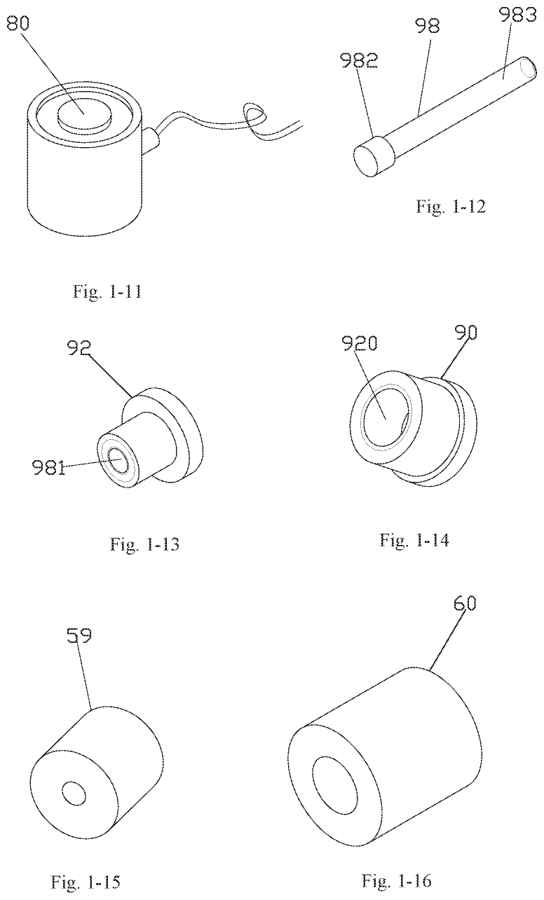

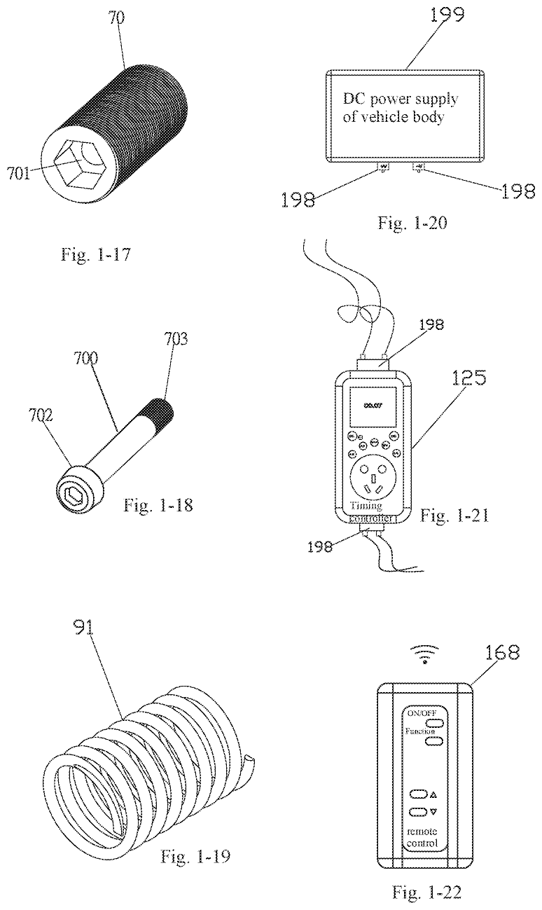

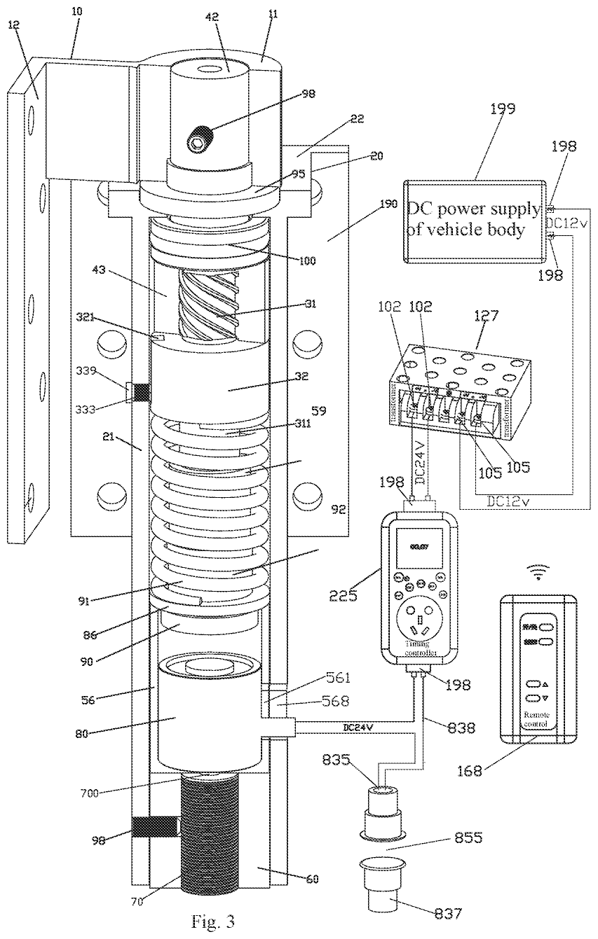

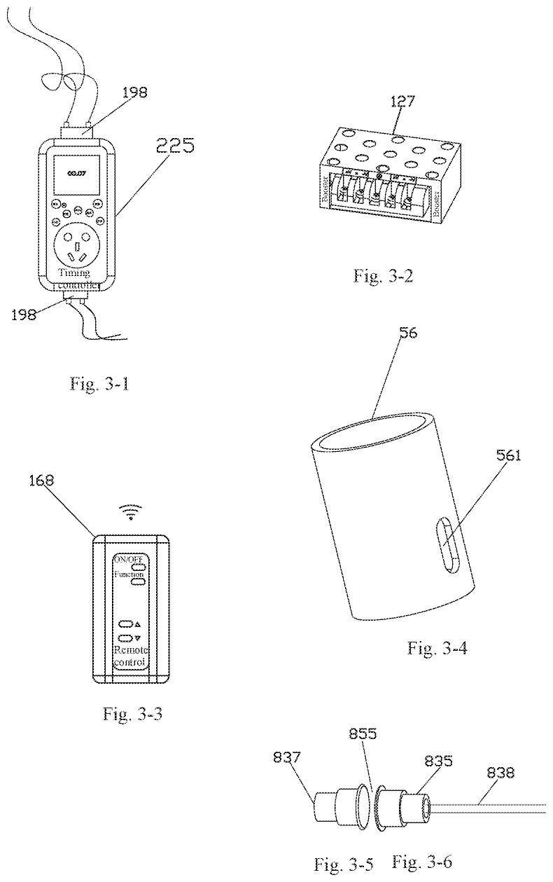

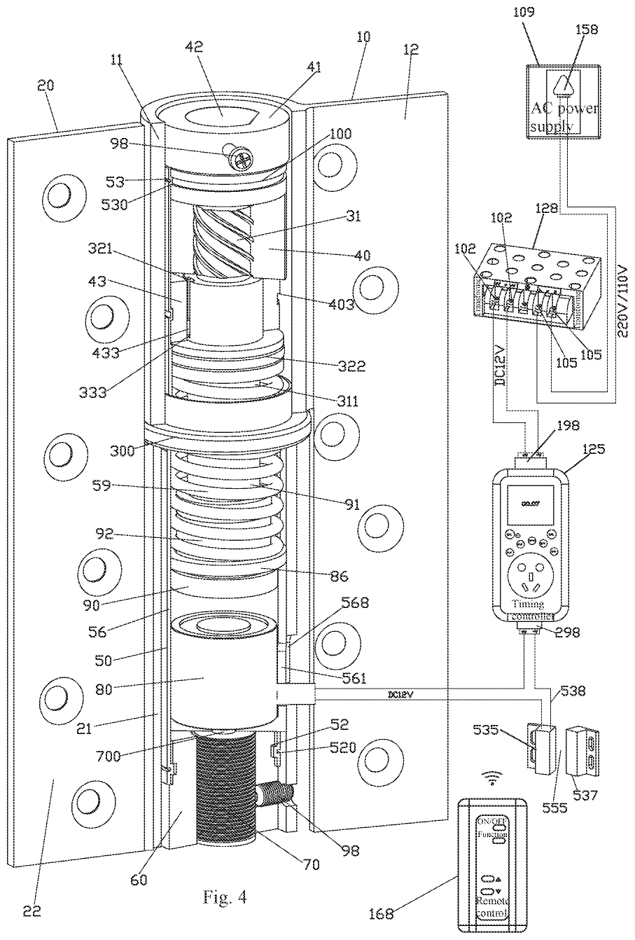

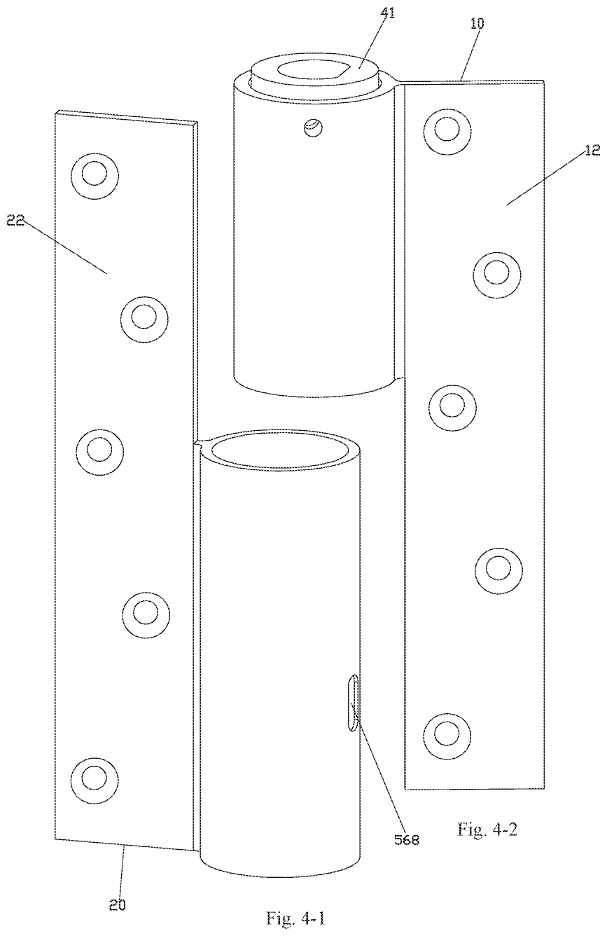

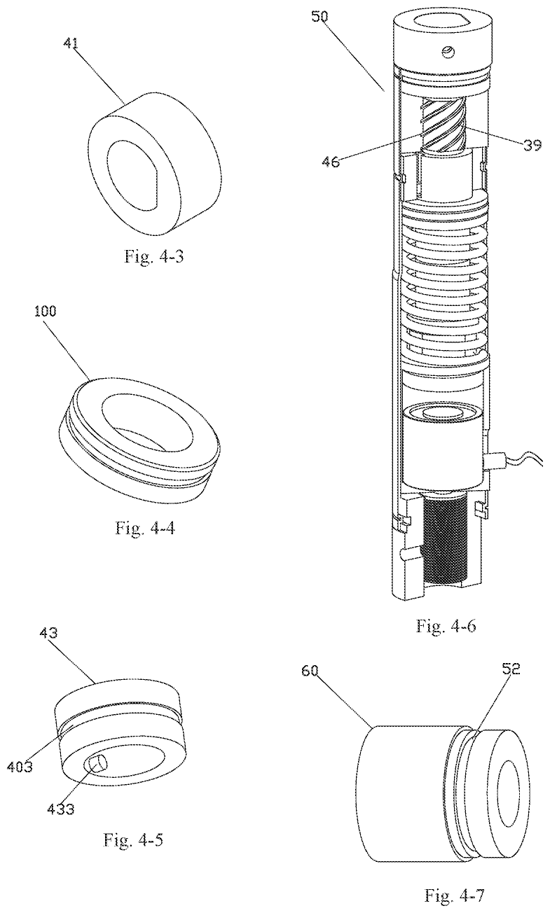

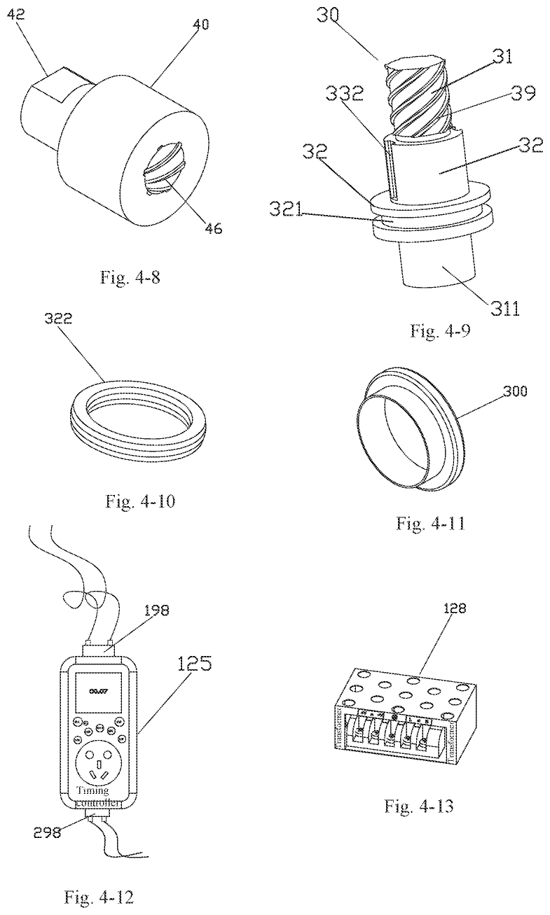

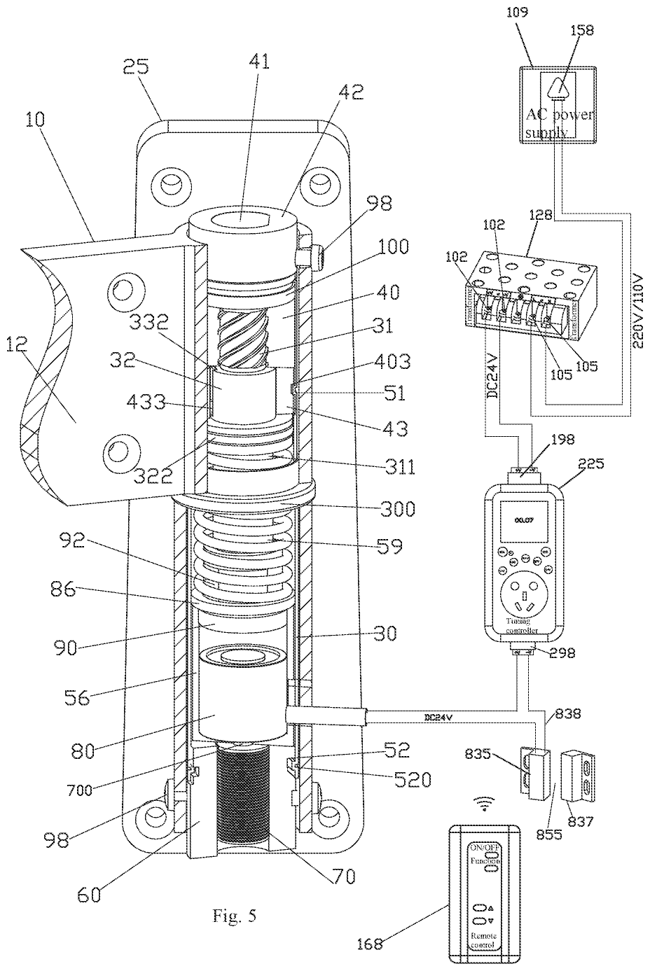

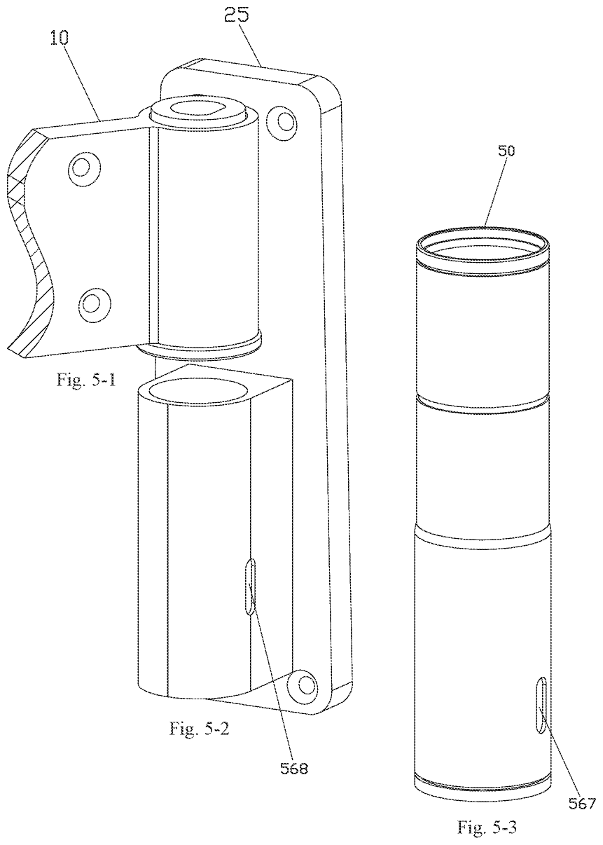

Referring to FIGS. 1 to 1-22, the hinge comprises a first hinge blade 10, a second hinge blade 20, a first bearing 100, a threaded sleeve 40, a fixed rod 30, the first spring 91, the electromagnet suction disk 90, the 12 volt DC power supply electromagnet 80, the 12 volt DC power supply timing controller 125, a wireless remote control 168, a plug 60, and an adjusting base 70. The first hinge blade 10 is disposed with a first blade 12 and two first shaft sleeves 11 separately fixed on the first blade 12, and the first blade 12 of the first hinge blade 10 defines a folded blade shape (it may not define the folded blade shape). The second hinge blade 20 comprises two separate second blades 22 fixed on a hinge blade fixed base 19. The two separate second blades 22 are fixed on a second shaft sleeve 21, and a wheelbase of the second shaft sleeve 21 corresponds to a distance between the two first shaft sleeves 11. The second shaft sleeve 21 is correspondingly disposed between the two first shaft sleeves 11. A fixed connection threaded rod 98 is disposed to pass through a threaded rod through hole of the hinge blade fixed base 19 and then to pass through a threaded rod through hole of a vehicle door frame, so that the hinge blade fixed base 19 is fixed on the vehicle door frame. An upper part of a through hole of an inner ring of the second shaft sleeve 21 is concave to define a groove platform 101, and a first gasket 95 is encompassed in and is flatly disposed on the groove platform 101 and is disposed between the two first shaft sleeves 11 and the second shaft sleeve 21. A lower part of the through hole of the inner ring of the second shaft sleeve 21 is also concave to define a groove platform 201, and a second gasket 85 is encompassed and is flatly disposed on the groove platform 201 and is disposed between the two first shaft sleeves 11 and the second shaft sleeve 21. The first gasket 95 and the second gasket 85 can help to strengthen the first blade 12 to be opened and automatically closed more smoothly. The threaded sleeve 40 is rotatably connected to the inner ring of the second shaft sleeve 21 and is not configured to move and slide. An upper part of the threaded sleeve 40 protrudes to define a transmission rod 42. The transmission rod 42 is configured to rotatably pass through the first bearing 100, to pass through the groove platform 101 of the second shaft sleeve 21, and to be disposed in a through hole of an inner ring of one of the two first shaft sleeves 11. The transmission rod 42 is correspondingly disposed in the through hole of the inner ring of the first shaft sleeve 11, and the fixed connection threaded rod 98 is screwed to the first shaft sleeve 11 and the transmission rod 42 to enable the first shaft sleeve 11 to be fixed on a part of the transmission rod 42 extending out of the second shaft sleeve 21, so that the first shaft sleeve 11 and the transmission rod 42 are fixed together. A wheelbase and an axial direction in which the fixed rod 30 is configured to move and slide up and down along an axis of the threaded sleeve 40 is positioned and limited and does not change. The fixed rod 30, the first spring 91, the 12 volt DC power supply electromagnet 80, the electromagnet suction disk 90, a rubber column 59, the cup body 56, the plug 60, and the adjusting base 70 are disposed between the threaded sleeve 40 and the plug 60 disposed in the second shaft sleeve 21.

A polished rod section of the fixed connection threaded rod 98 of a cap sleeve passes through a through hole of an inner ring of a cap sleeve 92 of the electromagnet suction disk 90 and then passes through a through hole of an inner ring of the rubber column 59, and a threaded section 983 of the fixed connection threaded rod 98 of the cap sleeve is screwed to a threaded tooth hole of a connection rod 311 of the fixed rod 30. A threaded rod head 982 of the fixed connection threaded rod 98 of the cap sleeve abuts a step 981 of the through hole of the inner ring of the cap sleeve 92 of the electromagnet suction disk 90, and the threaded section 983 is screwed to the threaded tooth hole of the connection rod 311 of the fixed rod 30. Therefore, after the electromagnet suction disk 90, the rubber column 59, and the connection rod 311 of the fixed rod 30 are connected together, the cap sleeve 92 of the electromagnet suction disk 90 is screwed in a threaded tooth hole 920 of an inner ring of a cylinder of the electromagnet suction disk 90 to enable the cap sleeve 92 of the electromagnet suction disk 90 to be connected to the electromagnet suction disk 90, so that the electromagnet suction disk 90, the rubber column 59, and the connection rod 311 are configured to slide and move up and down together. The fixed connection threaded rod 98 of the cap sleeve is further configured to limit the electromagnet suction disk 90 and the rubber column 59 from being separated from the fixed connection threaded rod 98 of the cap sleeve. A polished rod section of a fixed connection threaded rod 700 of the 12 volt DC power supply electromagnet 80 passes through a through hole of an inner ring of the adjusting base 70 and then passes through a threaded rod through hole of a cup bottom of the cup body 56, and a threaded section 703 of the fixed connection threaded rod 700 of the 12 volt DC power supply electromagnet 80 is screwed in a threaded tooth hole of the 12 volt DC power supply electromagnet 80. A threaded rod head 702 of the fixed connection threaded rod 700 of the 12 volt DC power supply electromagnet 80 abuts a step 701 of the through hole of the inner ring of the adjusting base 70, so that the adjusting base 70, the fixed connection threaded rod 700 of the 12 volt DC power supply electromagnet 80, and the 12 volt DC power supply electromagnet 80 are connected together. Therefore, the adjusting base 70 is adjusted to rotate to correspondingly cooperate with the plug 60, the fixed connection threaded rod 700 of the 12 volt DC power supply electromagnet 80, the cup bottom of the cup body 56, and the 12 volt DC power supply electromagnet 80. Therefore, a required distance between the 12 volt DC power supply electromagnet 80 and the electromagnet suction disk 90 is adjusted, and the 12 volt DC power supply electromagnet 80 and the electromagnet suction disk 90 are magnetically coupled together to be positioned in an inner ring of the cup body 56. At the same time, the adjusting base 70 is configured to synchronously and correspondingly adjust the blades of the hinge blades to be automatically positioned at a preset positioning angle within a required preset positioning angle. The fixed connection threaded rod 700 of the 12 volt DC power supply electromagnet 80 is further configured to limit the 12 volt DC power supply electromagnet 80 from being separated from the fixed connection threaded rod 700 of the 12 volt DC power supply electromagnet 80 disposed in the adjusting base 70.

The first blade 12 of the first hinge blade 10 is pushed to be opened in a left rotation direction. Therefore, the first shaft sleeve 11 is configured to drive the transmission rod 42 disposed in the first shaft sleeve 11 and the threaded sleeve 40 disposed in the second shaft sleeve 21 to axially slide downward to compress an elastic force energy storage of the first spring 91. The threaded rod 31 disposed in the second shaft sleeve 21 is configured to rotate relative to the threaded sleeve 40 disposed in the second shaft sleeve 21, and a cylinder front surface of a convex ring 32 of the fixed rod 30 is configured to downwardly slide in an axial direction to compress the elastic force energy storage of the first spring 91. At the same time, a straight oblique pitch of convex threaded teeth 39 of two or more (i.e., six) of six forward straight oblique pitches of the threaded rod 31 of the fixed rod 30 cooperates with and is screwed to a straight oblique pitch of concave threaded teeth 46 of two or more (e.g., six) of six forward straight oblique pitches of the threaded sleeve 40. Therefore, the distance of the wheelbase that the threaded rod is configured to move relative to the threaded sleeve 40 up and down can be preset, and a releasing force of the elastic force energy storage of the first spring 91 can be synchronously limited and preset. A speed of the first blade 12 of the first hinge blade 10 is preset when the first hinge blade 10 automatically rotating rightward to be closed, and the threaded rod 31 configured to axially move up and down relative to the threaded sleeve 40 is within a preset angle of rotation of the hinge blades (at the same time, a size value of a straight oblique pitch of the convex threaded teeth 39 of the two or more of the six forward straight oblique pitches of the threaded rod 31 of the fixed rod 30 can be set from 15 degrees of the straight oblique pitch of the convex threaded teeth 39 of the two or more of the six forward straight oblique pitches to about 129 degrees of the straight oblique pitch. When the size value of a straight oblique pitch of the convex threaded teeth 39 of two or more of the six forward straight oblique pitches becomes larger or is larger, and the distance size of the axial direction and the wheelbase of the threaded rod 31 configured to axially move and slide up and down relative to the threaded sleeve 40 becomes larger or is larger. The preset positioning angle position of the first blade 12 of the first hinge blade 10 of the hinge blades becomes larger or is larger. At the same time, the elastic force energy storage of the first spring 91 compressed due to the convex ring 32 of the fixed rod 30 axially sliding or moving downward becomes larger or is larger. The force of the stored energy of the first spring 91 will be relatively greater or be greater. The size value of a straight oblique pitch of the convex threaded teeth 39 of two or more of the six forward straight oblique pitches of the threaded rod 31 of the fixed rod 30 is configured to correspondingly cooperate with and be screwed to a forward straight oblique pitch that is defined with respect to a size value of a straight oblique pitch of concave threaded teeth 46 of two or more of six forward straight oblique pitches of the threaded sleeve. The size value of the straight oblique pitch of the concave threaded teeth 46 of two or more of the six forward straight oblique pitches of the threaded sleeve is preset from 15 degrees of the straight oblique pitch of the concave threaded teeth 46 of the two or more of the six forward straight oblique pitches to about 129 degrees of the straight oblique pitch. The distance size of the axial direction and the wheelbase of the threaded rod 31 configured to axially move and slide up and down relative to the threaded sleeve 40 becomes larger or is larger. The preset positioning angle position of the first blade 12 of the first hinge blade 10 of the hinge blades becomes larger or is larger. At the same time, the elastic force energy storage of the first spring 91 is compressed due to the cylinder front surface of the convex ring 32 of the fixed rod 30 axially sliding or moving downward and becoming larger or is larger. The straight oblique pitch of the concave threaded teeth 46 of two or more of the six forward straight oblique pitches of the threaded sleeve is configured to correspondingly cooperate with and is screwed to the straight oblique pitch of the convex threaded teeth 39 of two or more of six forward straight oblique pitches of the threaded rod 31 of the fixed rod 30). An electromagnetic force of the 12 volt DC power supply electromagnet 80 and the electromagnet suction disk 90 applied to the fixed rod 30 counteracts a pushing force transformed from the elastic force energy storage of the first spring 91, so that the first blade 12 of the first hinge blade 10 can be automatically positioned within a preset positioning angle of a rotation, and the structure is convenient to use. The adjusting base 70 disposed in the plug 60 is adjusted to rotate to correspondingly cooperate with the plug 60, the fixed connection threaded rod 700 of the 12 volt DC power supply electromagnet 80, the cup bottom of the cup body 56, and the 12 volt DC power supply electromagnet 80. Therefore, the required distance of the 12 volt DC power supply electromagnet 80 and the electromagnet suction disk 90 is adjusted, and the 12 volt DC power supply electromagnet 80 and the electromagnet suction disk 90 can be magnetically coupled together to be positioned on an inner ring of the cup body 56. At the same time, the adjusting base 70 is also configured to synchronously and correspondingly adjust the first blade 12 of the first hinge blade 10 to be automatically positioned at the required preset positioning angle. At the same time, the 12 volt DC power supply timing controller 125 is configured to preset a duration by which the 12 volt DC power supply electromagnet 80 is magnetically coupled to the electromagnet suction disk 90 by mobile phone remote control, voice control, wireless remote control, electronic intelligence control, or manual control of a preset button for an automatic positioning duration of the 12 volt DC power supply timing controller 125 that the hinge blades are automatically positioned at the preset positioning angle. At the same time, the 12 volt DC power supply timing controller 125 can also synchronically and correspondingly preset the automatic positioning duration of the first blade 12 of the first hinge blade 10 at the preset positioning angle, so that the first blade 12 of the first hinge blade 10 can be automatically positioned at the preset positioning angle. When the first blade 12 of the first hinge blade 10 reaches an automatic positioning time of the first blade 12 of the first hinge blade 10 preset by the 12 volt DC power supply timing controller 125, it is also a demagnetization time by which the 12 volt DC power supply electromagnet 80 is magnetically coupled to the electromagnet suction disk. At the same time, the first spring 91 is in an elastic force energy storage state of the first spring 91 compressed by a downward high pressure from the cylinder front surface of the convex ring 32 of the fixed rod 30 to enable the elastic force energy storage of the first spring 91 to change and release, so that the elastic force energy storage of one end of the first spring 91 can strongly abut the cylinder front surface of the convex ring 32, and the elastic force energy storage of another end can strongly abut the gasket 86 disposed on a front plane of the cup body 56, so that the first blade 12 of the first hinge blade 10 itself can automatically close the vehicle door hinge in a rightward rotation direction.

For example, the first blade 12 of the first hinge blade 10 needs to be automatically positioned in a 90 degree positioning angle position within the preset positioning angle, when the first blade 12 of the first hinge blade 10 is opened to the required 90-degree preset positioning angle in a leftward rotation direction, the first blade 12 is configured to drive the transmission rod 42 and the threaded sleeve 40 to rotate, the threaded rod 31 is configured to axially and downwardly slide relative to the threaded sleeve 40 to compress the elastic force energy storage of the first spring 91, and the threaded rod 31 moves relative to the threaded sleeve 40. At the same time, the first spring 91 is in the elastic force energy storage state of the first spring 91 that is compressed by a downward high pressure from the cylinder front surface of the convex ring 32 of the fixed rod 30. At the same time, the threaded rod 31 of the fixed rod 30 and the electromagnet suction disk 90 correspondingly cooperate with the first blade 12 of the first hinge blade 10 and are configured to move and slide downward to a preset positioning angle at which the first blade 12 of the first hinge blade 10 is opened to 90 degrees, and the first blade 12 of the first hinge blade 10 is opened to a 90 degree positioning angle of the required preset positioning angle. At the same time, the first blade 12 of the first hinge blade 10 has no positioning function. At the same time, when the first blade 12 of the first hinge blade 10 needs to be positioned at the 90 degree positioning angle position of the preset positioning angle by the adjusting base 70 disposed in the plug 60, the adjusting base 70 is adjusted to rotate to enable the adjusting base 70 to correspondingly cooperate with the plug 60, the 12 volt DC power supply electromagnet 80, the fixed connection threaded rod 700 of the 12 volt DC power supply electromagnet 80, and the cup bottom of the cup body 56. Therefore, the required distance between the 12 volt DC power supply electromagnet 80 and the electromagnet suction disk 90 is adjusted, and the 12 volt DC power supply electromagnet 80 and the electromagnet suction disk 90 are magnetically coupled together to be positioned in the cup body 56. At the same time, the adjusting base 70 is configured to synchronously and correspondingly adjust a required 90-degree preset positioning angle of the first blade 12 of the first hinge blade 10, so that the first blade 12 of the first hinge blade 10 is configured to be automatically positioned at a starting point of the 90-degree preset positioning angle within the preset positioning angle between 30 degrees to 180 degrees. However, after the first blade 12 of the first hinge blade 10 is also opened to a 180 degree angle of a preset rotation maximum point of the first blade 12 of the first hinge blade 10, the elastic force energy storage state of the first spring 91 is compressed by a downward high pressure from the cylinder front surface of the convex ring 32 of the fixed rod 30 to enable the elastic force energy storage of the first spring 91 to change and release, so that the elastic force energy storage of the one end of the first spring 91 can strongly abut the convex ring 32, and the elastic force energy storage of the another end can strongly abut the gasket 86 disposed on the front plane of the cup body 56. At the same time, the rubber column 59 is in an elastic force energy storage state of the rubber column 59 that is compressed by a downward high pressure due to the convex ring 32 of the fixed rod 30 cooperating with the cap sleeve 92 to enable the elastic force energy storage of the rubber column 59 to change and to enable the elastic force energy storage of the rubber column 59 to release, so that the elastic force energy storage of one end of the rubber column 59 can strongly abut the cylinder front surface of the convex ring 32, and the elastic force energy storage of the another end of the rubber column 59 can strongly abut the cap sleeve 92 of the electromagnet suction disk 90. Therefore, the first spring 91 and the rubber column 59 are configured to enable the first blade 12 of the first hinge blade 10 to rotate rightward to be closed, and the first blade 12 of the first hinge blade 10 rotates rightward to return to be automatically positioned at the 90 degree preset positioning angle position adjusted in place by the adjusting base 70 disposed in the plug 60. When the first blade 12 of the first hinge blade 10 needs to be closed, the 12 volt DC power supply timing controller 125 is configured to preset the demagnetization time by which the 12 volt DC power supply electromagnet 80 is magnetically coupled to the electromagnet suction disk 90 by mobile phone remote control, voice control, wireless remote control, electronic intelligence control, or manual control of the preset button for the automatic positioning duration of the 12 volt DC power supply timing controller 125 by which the hinge blades are automatically positioned at the preset positioning angle position. When a positioning time of the first blade 12 of the first hinge blade 10 positioned at the positioning angle position reaches the automatic positioning time of the first blade 12 of the first hinge blade 10 preset by the 12 volt DC power supply timing controller 125, at the same time, the first spring 91 is in the elastic force energy storage state of the first spring 91 is compressed by the downward high pressure from the cylinder front surface of the convex ring 32 of the fixed rod 30 to enable the elastic force energy storage of the first spring 91 to change and release, so that the elastic force energy storage of the one end of the first spring 91 can strongly abut the cylinder front surface of the convex ring 32, and the elastic force energy storage of the another end can strongly abut the gasket 86 disposed on the front plane of the cup body 56. The first spring 91 is configured to enable the first blade 12 of the first hinge blade 10 to rotate rightward to be closed backward, and the first blade 12 of the first hinge blade 10 achieves a close due to an automatic rightward rotation. The rubber column 59 can also be replaced by a non-ferrous metal spring of a non-ferrous metal elastic body. A side surface of the cup body 56 is disposed is disposed with a power supply wire through hole 561 in an axial direction along an inner ring and an outer ring and a distance of a wheel base of the cup body 56. An axial direction disposed along an inner ring and an outer ring and a distance of a wheel base of the second shaft sleeve 21 is disposed with a power supply wire through hole 568 disposed on a side surface of the second shaft sleeve 21, and the power supply wire through hole 561 disposed on the side surface of the cup body 56 is aligned with and is in communication with the power supply wire through hole 568 disposed on the side surface of the second shaft sleeve 21, and the axial direction along the inner ring and the outer ring and the distance of the wheel base are aligned and are in communication. Therefore, a power supply wire of the 12 volt DC power supply electromagnet 80 passes through the power supply wire through hole 561 and the power supply wire through hole 568 and is connected to a power supply wire connector 198 of the 12 volt DC power supply timing controller 125.

One end of the 12 volt DC power supply timing controller 125 is connected to a 12 volt positive DC power supply wire connector 198. The DC power supply wire connector 198 is connected to a 12 volt positive DC power supply base of the vehicle body to enable the 12 volt DC power supply timing controller 125 to be connected to the 12 volt DC power supply base of the vehicle body. Another end of the 12 volt DC power supply timing controller 125 is connected to a 12 volt negative DC power supply wire connector 198. The 12 volt negative DC power supply wire connector 198 is connected to the 12 volt DC power supply electromagnet 80, so that the 12 volt DC power supply electromagnet 80 is connected to the 12 volt DC power supply timing controller 125. The 12 volt DC power supply timing controller 125 functions by mobile phone remote control, voice control, wireless remote control, electronic intelligence control, or manual control of the preset button for an automatic positioning duration of the 12 volt DC power supply timing controller 125 by which the hinge blades are automatically positioned at the preset positioning angle position. The duration by which the 12 volt DC power supply electromagnet 80 is magnetically coupled to the electromagnet suction disk 90 each time is preset. At the same time, the 12 volt DC power supply timing controller 125 can also synchronically and correspondingly preset the automatic positioning duration of the first blade 12 of the first hinge blade 10 that is automatically positioned at the preset positioning angle position each time. Therefore, for example, a duration by which the 12 volt DC power supply electromagnet 80 is magnetically coupled to the electromagnet suction disk 90 each time is configured to be preset from 1 second to any time within 24 hours by the 12 volt DC power supply timing controller 125 and is configured to be the duration by which the 12 volt DC power supply electromagnet 80 is fixedly and magnetically coupled to the electromagnet suction disk 90 each time. At the same time, a duration by which the first blade 12 of the first hinge blade 10 is automatically positioned each time is configured to be preset from 1 second to any time within 24 hours by the 12 volt DC power supply timing controller 125 and is configured to be the duration by which the first blade 12 of the first hinge blade 10 is automatically positioned at the preset positioning angle position each time. Therefore, the duration by which the 12 volt DC power supply electromagnet 80 is magnetically coupled to the electromagnet suction disk 90 each time is fixedly configured to be preset from 1 second to 8 seconds within 24 hours by the 12 volt DC power supply timing controller 125 and is configured to be 8 seconds by which the 12 volt DC power supply electromagnet 80 is fixedly and magnetically coupled to the electromagnet suction disk 90 each time. Therefore, the 12 volt DC power supply timing controller 125 functions by mobile phone remote control, voice control, wireless remote control, electronic intelligence control, or manual control of the preset button for the automatic positioning duration of the 12 volt DC power supply timing controller 125 by which the hinge blades are automatically positioned at the preset positioning angle position. The 12 volt DC power supply timing controller 125 is configured to preset the 12 volt DC power supply electromagnet 80 to be fixedly and magnetically coupled to the electromagnet suction disk 90 each time, and each time for the fixed magnetic coupling is 8 seconds. At the same time, the 12 volt DC power supply timing controller 125 can also synchronously preset the first blade 12 of the first hinge blade 10 to be fixedly and automatically positioned at the preset positioning angle position each time, and the automatic positing duration is 8 seconds. When the first blade of the first hinge blade 10 reaches a fixed 8 second demagnetization time preset by the 12 volt DC power supply timing controller 125 by which the 12 volt DC power supply electromagnet 80 is magnetically coupled to the electromagnet suction disk, an automatic 8 second duration preset by the 12 volt DC power supply timing controller 125 by which the first blade of the first hinge blade 10 is automatically positioned at the preset positioning angle position reaches. At the same time, the first spring 91 is in the elastic force energy storage state of the first spring 91 that is compressed by the downward high pressure from the cylinder front surface of the convex ring 32 of the fixed rod 30 to enable the elastic force energy storage of the first spring 91 to change and release, so that the elastic force energy storage of the one end of the first spring 91 can strongly abut the cylinder front surface of the convex ring 32, and the elastic force energy storage of the another end can strongly abut the gasket 86 disposed on the front plane of the cup body 56, so that the first blade 12 of the first hinge blade 10 itself can automatically rotate rightward to close the vehicle door hinge blade.

The 12 volt DC power supply timing controller 125 functions by mobile phone remote control, voice control, wireless remote control, electronic intelligence control, or manual control of the preset button for the automatic positioning duration of the 12 volt DC power supply timing controller 125 by which the hinge blades are automatically positioned at the preset positioning angle position. The 12 volt DC power supply timing controller 125 releases the fixed 8 second demagnetization time preset by the 12 volt DC power supply timing controller 125 in advance at a first 7 second demagnetization time, a first 5 second demagnetization time, a first 3 second demagnetization time, etc. of the 12 volt DC power supply electromagnet 80, which can all be an advance demagnetization time of the 12 volt DC power supply electromagnet 80. At the same time, the 12 volt DC power supply timing controller 125 enables the time preset button of the 12 volt DC power supply timing controller 125 to be pressed by the external force, so that the 12 volt DC power supply timing controller 125 is configured to synchronously release the automatic positioning of the first blade 12 of the first hinge blade 10 preset by the 12 volt DC power supply timing controller 125 at the preset positioning angle, is first 7 seconds, first 5 seconds, first 3 seconds, etc. that are before 8 seconds fixed automatic positioning each time, which can all be an advance automatic close time of the first blade 12 of the first hinge blade 10. Therefore, after the first blade 12 of the first hinge blade 10 is configured to correspondingly cooperate with the 12 volt DC power supply electromagnet 80 in advance at the first 7 second demagnetization time, the first 5 second demagnetization time, the first 3 second demagnetization time, etc. that are before 8 seconds to define the advance demagnetization time of the 12 volt DC power supply electromagnet 80, the first blade 12 of the first hinge blade 10 is automatically positioned at the preset positioning angle preset by the 12 volt DC power supply timing controller 125, each fixed automatic positioning is first 7 seconds, first 5 seconds, first 3 seconds, etc. that are before 8 seconds, which can all be the advance automatic close time of the first blade 12 of the first hinge blade 10 itself. At the same time, the first spring 91 is in the elastic force energy storage state of the first spring 91 compressed by the downward high pressure from the cylinder front surface of the convex ring 32 of the fixed rod 30 to enable the elastic force energy storage of the first spring 91 to change and release, so that the elastic force energy storage of the one end of the first spring 91 can strongly abut the cylinder front surface of the convex ring 32, and the elastic force energy storage of the another end can strongly abut the gasket 86 disposed on the front plane of the cup body 56, the first blade 12 of the first hinge blade 10 of the vehicle door hinge itself can automatically rotate rightward to be closed at a first several second before 8 seconds in advance. A wireless remote control 168 of the 12 volt DC power supply timing controller 125 is configured to press the duration preset button of the wireless remote control 168 by the external force, the wireless remote control 168 is configured to remotely release the fixed 8 second demagnetization time preset by the 12 volt DC power supply timing controller 125 in advance at the first 7 second demagnetization time, the first 5 second demagnetization time, the first 3 second demagnetization time, etc. of the 12 volt DC power supply electromagnet 80, which can all be an advance demagnetization time of the 12 volt DC power supply electromagnet 80. At the same time, the wireless remote control 168 is configured to press the duration preset button of the wireless remote control 168 by the external force. Therefore, the wireless remote control 168 is configured to synchronously release the automatic positioning of the first blade 12 of the first hinge blade 10 preset by the 12 volt DC power supply timing controller 125 at the preset positioning angle, first 7 seconds, first 5 seconds, first 3 seconds etc. that are before 8 seconds fixed automatic positioning each time, which can all be the advance automatic close time of leftward rotation of the first blade 12 of the first hinge blade 10 itself. Therefore, after the first blade 12 of the first hinge blade 10 is configured to correspondingly cooperate with the 12 volt DC power supply electromagnet 80 in advance at the first 7 second demagnetization time, the first 5 second demagnetization time, the first 3 second demagnetization time, etc. that are before 8 seconds to define the advance demagnetization time of the 12 volt DC power supply electromagnet 80. At the same time, the first spring 91 is in the elastic force energy storage state of the first spring 91 compressed by the downward high pressure from the cylinder front surface of the convex ring 32 of the fixed rod 30 to enable the elastic force energy storage of the first spring 91 to change and release, so that the elastic force energy storage of the one end of the first spring 91 can strongly abut the cylinder front surface of the convex ring 32, and the elastic force energy storage of the another end can strongly abut the gasket 86 disposed on the front plane of the cup body 56, so that the first blade 12 of the first hinge blade 10 itself can automatically rotate rightward to be closed before 8 seconds in advance.

A magnet body 537 without a lead wire 538 of a first portion of a 12 volt DC power supply door magnetic switch 555 is also configured to be disposed on a vehicle door lock or a vehicle door blade and an assembly position is aligned and matched with a sensor 535 with a lead wire 538 of the vehicle door frame. The sensor 535 with the lead wire 538 of a second portion of a 12 volt DC power supply door magnetic switch 555 is disposed on the vehicle door frame and an assembly position is aligned and matched with the magnet body 537 without the lead wire 538 of the 12 volt DC power supply door magnetic switch 555 of the vehicle door lock or the vehicle door blade. A positive lead wire of the sensor 535 with the lead wire 538 of the 12 volt DC power supply door magnetic switch 555 is connected to the 12 volt DC power supply timing controller 125, and a negative lead wire 538 of the sensor 535 is connected to the 12 volt DC power supply electromagnet 80. Another solution is alternative here that the sensor 535 with the lead wire 538 of the first portion of the 12 volt DC power supply door magnetic switch 555 is also disposed on the vehicle door lock or the vehicle door blade, and the magnet body 537 without the lead wire 538 of the second portion of the 12 volt DC power supply door magnetic switch 555 is also disposed on the vehicle door frame and the assembly position is aligned and matched with the sensor 535 with the lead wire 538 of the 12 volt DC power supply door magnetic switch 555 of the vehicle door lock or the vehicle door blade. When an electronic smart lock of the vehicle door lock or the vehicle door blade enables the electronic smart lock of the vehicle door lock or the vehicle door blade to be opened by electronic password intelligent sensor, a swipe sensor, a fingerprint sensor, or a conventional key, etc., and the door blade is opened to be automatically positioned at the preset positioning angle position of the first blade 12 of the first hinge blade 10 and the vehicle door blade. At the same time, the vehicle door blade drives the magnet body 537 without the lead wire 538 of the 12 volt DC power supply door magnetic switch 555 of the vehicle door lock or the vehicle door blade to be synchronously separated from the sensor 535 with the lead wire 538 of the vehicle door frame. When the magnet body 537 without the lead wire 538 of the 12 volt DC power supply door magnetic switch 555 of the vehicle door lock or the vehicle door blade is separated from the sensor 535 with the lead wire 538 of the 12 volt DC power supply door magnetic switch 555 of the door frame by more than 10 mm, that is, the vehicle door frame is just opened a little clearance, at the same time, the 12 volt DC power supply timing controller 125 and the 12 volt DC power supply electromagnet 80 start power-on states. At the same time, 12 volt DC power supply electromagnet 80 starts to open the duration preset by the 12 volt DC power supply timing controller 125 that the electromagnet is magnetically coupled to the electromagnet suction disk each time. At the same time, the vehicle door frame is opened to be automatically positioned at the preset positioning angle of the first blade 12 of the first hinge blade 10. When the first blade 12 of the first hinge blade 10 and the vehicle door frame reach the demagnetization time preset by the 12 volt DC power supply timing controller 125 that the 12 volt DC power supply electromagnet 80 is magnetically coupled to the electromagnet suction disk 90 each time, at the same time, the automatic positioning duration preset by the 12 volt DC power supply timing controller 125 that the first blade 12 of the first hinge blade 10 is fixed at the preset positioning angle position each time reaches, at the same time, the first spring 91 is in the elastic force energy storage state of the first spring 91 compressed by the downward high pressure from the cylinder front surface of the convex ring 32 of the fixed rod 30 to enable the elastic force energy storage of the first spring 91 to change and release, so that the elastic force energy storage of the one end of the first spring 91 can strongly abut the cylinder front surface of the convex ring 32, and the elastic force energy storage of the another end can strongly abut the gasket 86 disposed on the front plane of the cup body 56, so that the first blade 12 of the first hinge blade 10 itself can automatically rotate to close the vehicle door blade. Further, the positioning duration that the first blade 12 of the first hinge blade 10 and the vehicle door blade are opened to the preset positioning angle position to be automatically positioned each time will repeat the positioning duration preset by the 12 volt DC power supply timing controller 125 that the first blade 12 of the first hinge blade 10 and the vehicle door blade are configured to be automatically positioned at the required preset positioning angle position each time.

The 12 volt DC power supply timing controller 125 is configured to correspondingly cooperate with the wireless remote control 168, so that the wireless remote control 168 enables a preset button of the wireless remote control 168 for the automatic positioning duration that the hinge blades can be automatically positioned at the preset positioning angle position to be pressed by manual force. Therefore, the 12 volt DC power supply timing controller 125 is remotely controlled, and the wireless remote control 168 is configured to preset the duration that the 12 volt DC power supply electromagnet 80 is magnetically coupled to the electromagnet suction disk 90. For example, the preset button for the automatic positioning duration that the hinge blades can be automatically positioned at the preset positioning angle position of the wireless remote control 168 is pressed, is configured to be remotely preset from 1 second to any time within 24 hours, and is configured to be the duration that the 12 volt DC power supply electromagnet 80 is fixedly and magnetically coupled to the electromagnet suction disk 90 each time. At the same time, the wireless remote control 168 is configured to synchronize the preset button of the wireless remote control 168 using manual force for the automatic positioning duration that the hinge blades can be automatically positioned at the preset positioning angle position to remotely preset the duration that the first blade 12 of the first hinge blade 10 is positioned at the preset positioning angle position each time. For example, the preset button of the wireless remote control 168 using external force for the automatic positioning duration that the hinge blades can be automatically positioned at the preset positioning angle position each time enables the wireless remote control 168 to remotely preset the automatic duration configured to be preset from 1 second to any time within 24 hours that the first blade 12 of the first hinge blade 10 is positioned at the preset positioning angle position, which are remotely preset to be the automatic positioning duration of the first blade 12 of the first hinge blade 10.

In a detailed structure, a tail end of the threaded rod 31 comprises the fixed convex ring 32, the convex ring 32 is fixed on the connecting rod, and an outer ring of the convex ring 32 is concave to circumferentially define a convex ring sliding trail groove 332. A fixed sliding rod passes through the threaded rod through hole of the second shaft sleeve 21 and slides into and abuts an inner side of the convex ring sliding trail groove 332, so that the fixed sliding rod 339 is configured to correspondingly cooperates with the convex ring sliding trail groove 332, and sizes of the axial direction, the wheelbase, and the circumferential direction that fixed rod 30 axially slides and moves up and down relative to the threaded sleeve is limited and positioned and will not change. The fixed sliding rod 339 is encompassed in and is slidably connected to a sliding rotation sleeve tube 333, so that the fixed sliding rod 339 encompassed in and slidably connected to the sliding rotation sleeve tube 333 is configured to abut the inner side of the convex ring sliding trail groove 332 to help to strengthen a movement of the fixed rod configured to axially move and slide up and down relative to the threaded rod to be more smoothly and to enable the first blade 12 of the first hinge blade 10 to be opened and be closed more smoothly. The first bearing 100 rotatably encompasses and is connected to the transmission rod 42 in the second shaft sleeve 21 and is disposed the threaded sleeve 40 and the groove platform 101 of the second shaft sleeve 21. The first bearing 100 helps to strengthen the movement of the fixed rod configured to axially move and slide up and down relative to the threaded rod to be more smoothly and to enable the first blade 12 of the first hinge blade 10 to be opened and be closed more smoothly. The plug 60 is rotatably connected to an inner side of the second shaft sleeve 21, the portion extending out of the second shaft sleeve 21 passes through and is screwed to the threaded rod through hole of the first shaft sleeve 11 by the fixed connection threaded rod 98, locked to and passes through the plug 60, and then screwed and locked to and fixed with the adjusting base 70. At the same time, the fixed connection threaded rod 98 does not firstly cooperate with the first shaft sleeve 11 and the plug 60 together to be locked to and be fixed on the adjusting base 70, when the adjusting base 70 is adjusted to rotate to enable the adjusting base 70 to correspondingly cooperate with the plug 60, the 12 volt DC power supply electromagnet 80, the fixed connection threaded rod 700 of the electromagnet, and the cup bottom of the cup body 56. Therefore, the required distance between the 12 volt DC power supply electromagnet 80 and the electromagnet suction disk 90 is adjusted, and the 12 volt DC power supply electromagnet 80 and the electromagnet suction disk 90 are magnetically coupled together to be positioned in the cup body 56. At the same time, the adjusting base is configured to synchronously and correspondingly adjust the required preset positioning angle of the first blade 12 of the first hinge blade 10, so that the first blade 12 of the first hinge blade 10 is configured to be automatically positioned at the starting point of the required positioning angle position within the preset positioning angle. The waiting fixed connection threaded rod 98 starts again to be locked and screwed and fixed on the adjusting base 70 to prevent the adjusting base 70 from being loosen. However, the first blade 12 of the first hinge blade 10 is configured to be opened to a 180 degree angle of a maximum preset angle of the preset rotation of the first blade 12 of the first hinge blade 10.

### Embodiment 2

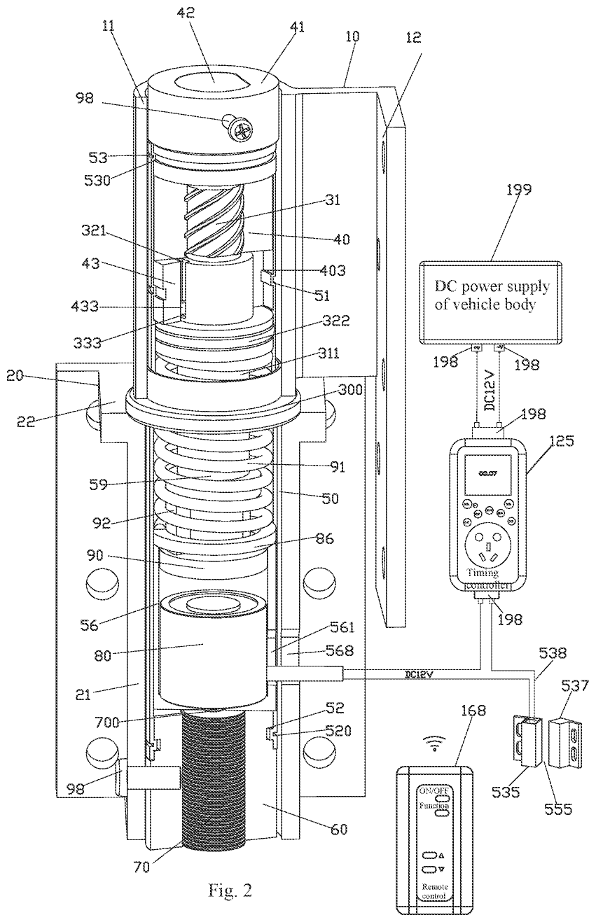

It differs from Embodiment 1 in that: referring to FIG. 2, the second hinge blade 20 comprises the second shaft sleeve 21 and a second blade 22, and the first hinge blade 10 comprises the first shaft sleeve 11 and the first blade 12. The first shaft sleeve 11 is disposed on an upper half part of the first blade 12, and the first blade 12 defines a folded-blade shape. The fixed connection threaded rod 98 is screwed to the threaded rod through hole of the first shaft sleeve 11, locked to the swivel ring 41, and then locked to and fixed on the transmission rod 42, so that the first shaft sleeve 11, the swivel ring 41, and the transmission rod 42 are fixed together. An inner side of the connecting sleeve 50 is disposed with a second flange 52, the second flange 52 is configured to abut an annular groove of the plug 60 in the connecting sleeve 50, so that the second flange 52 and the plug 60 are configured to be fixed in the connecting sleeve 50. A part of the plug 60 extending out of the connecting sleeve passes through and is screwed to the threaded rod through hole of the second shaft sleeve 21 by the fixed connection threaded rod 98, then locked to and fixed on the plug 60, so that the second shaft sleeve 21 and the plug 60 are fixed together. The threaded sleeve 40 is separated from the plug 60. The threaded sleeve 40 and the plug 60 disposed in the connecting sleeve 50 are disposed with the fixed rod 30, the first spring 91, the 12 volt DC power supply electromagnet 80, the electromagnet suction disk 90, the rubber column 59, the cup body 56, the plug 60, and the adjusting base 70.

The transmission rod 42 is rotatably but not movably connected to the inner side of the connecting sleeve 50 disposed in the first shaft sleeve 11, the swivel ring 41 is fixedly connected to the part of the transmission rod 42 extending out of the connecting sleeve 50, and the connection is disposed with the swivel ring 41. A flat cutting edge of a side surface of an outer ring of the transmission rod 42 corresponds with a flat cutting edge of an inner ring of an inner ring through hole of the swivel ring 41, and the swivel ring 41 is correspondingly disposed in an upper part of the first shaft sleeve 11, the first shaft sleeve 11, the swivel ring 41, and the transmission rod 42 are fixed together by the fixed connection threaded rod 98. Therefore, the swivel ring 41 and the first shaft sleeve 11 can further limit an axial movement of the threaded sleeve 40, the distance of the wheelbase and the axial direction that the threaded rod is configured to move relative to the threaded sleeve up and down is limited and will not change. When the two hinge blades relatively rotate, the threaded rod configured to slide and axially move up and down relative to the threaded sleeve is within a preset rotation angle of the rotation of the first blade 12.

The connecting sleeve 50 is connected to an inner side of the second shaft sleeve 21 and an inner side of the first shaft sleeve 11, and the first shaft sleeve 11 and the second shaft sleeve 21 are disposed side-to-side and up and down, so that the two hinge blades can rotate relatively. A third bearing 300 can also rotatably encompass an outer side of the connecting sleeve 50. The third bearing 300 is rotatably connected to a circumferential plane of one end of the second shaft sleeve 21 and is rotatably connected to and encompass a circumferential plane of one end of the first shaft sleeve 11, so that the first hinge blade 10 axially rotates more smoothly relative to the second hinge blade 20. A third flange 53 is disposed in the inner side of the connecting sleeve 50, and the third flange 53 is configured to abut the annular groove 530 of the first bearing 100 in the connecting sleeve 50, so that the third flange 53 is embedded to the annular groove 530 of the first bearing 100 in the connecting sleeve 50, so that the first bearing 100 and the third flange 53 are fixed in the connecting sleeve and are not configured to move up and down relatively (the third flange 53 is disposed in the connecting sleeve, so that the third flange 53 is configured to be embedded in the annular groove 530 of the first bearing 100 in the connecting sleeve 50 and limit the first bearing 100 to move axially), the first bearing 100 helps the rotation of the blades 12 of the two hinge blades 10 to be opened and closed more smoothly. The tail end of the threaded rod 31 of the fixed rod 30 comprises the fixed convex ring 32, and the convex ring 32 is fixed to the connecting rod 33. The first spring 91 encompasses the connecting rod 33, and one end of the first spring 91 is configured to abut the convex ring 32, and another end of the first spring 91 is configured to abut a circumferential plane of a front end of an auxiliary adjustment spring gasket 80.

Preferably, the first flange 51 is disposed in the connecting sleeve 50, the first flange 51 is configured to abut an annular groove 403 of a threaded ring 43 in the connecting sleeve 50, so that the first flange 51 is configured to be embedded to the annular groove 403 of the threaded ring 43 in the in the connecting sleeve 50. The threaded ring 43, the first flange 51, and the connecting sleeve 50 are connected together and are fixed in the connecting sleeve 50, so that the threaded ring 43 is fixed in connecting sleeve 50 and is not configured to rotate, slide, and move. The threaded ring 43 is concave to define a through hole, a circumferential front edge of an inner ring of the through hole of the threaded ring 43 protrudes to define an inner ring flange 433 of the threaded ring, and the inner ring flange 433 of the threaded ring is configured to abut the convex ring sliding trail groove 332, so that the inner ring flange 433 of the threaded ring is configured to correspondingly cooperate with the convex ring sliding trail groove 332 of the convex ring 32 of the fixed rod 30, so that the distance size of the axial direction and the wheelbase of the fixed rod configured to axially move and slide up and down relative to the threaded sleeve is positioned and limited and will not change. The threaded ring 43 is disposed below the threaded sleeve and the threaded rod 31 passes through the threaded ring 43 and is then screwed to the threaded sleeve 40, so that the threaded ring 43 is configure to limit and control the distance size of the axial direction and the wheelbase of the threaded rod 31 configured to axially move and slide up and down relative to the threaded sleeve 40 to not change. The tail end of the threaded rod 31 of the fixed rod 30 is fixed with the convex ring 32, the circumferential side surface of the outer ring of the convex ring 32 is concave to define the convex ring sliding trail groove 332. An outer ring of a tail end of the convex ring 32 is concave to circumferentially define an annular mounting groove 321, an inner side of the annular mounting groove 321 is encompassed in a sealing rubber ring 322. The sealing rubber ring 322 further extends out of the annular mounting groove 321, so that the convex ring 32 hermetically and slidably connected to and abuts the inner side of the second shaft sleeve 21, the sealing rubber ring disposed in the annular mounting groove 321 of the convex ring 32 is configured to limit the threaded rod 31 disposed in the second shaft sleeve 21 to axially move and slide up and down relative to the threaded sleeve 40 to generate a damping force and a resistance force, the sealing rubber ring disposed in the annular mounting groove 321 of the convex ring 32 is configured to limit a releasing strength of the elastic force energy storage of the first spring 91, and the sealing rubber ring disposed in the annular mounting groove 321 of the convex ring 32 is configured to limit a safe, damping, and automatic close of the first blade 12 of the first hinge blade 10 when being automatically closed. A tooth direction of up and down threaded teeth of an outer ring of the threaded rod 31 and all distance size stroke of up and down pitches of the outer ring of the threaded rod 31 of the convex threaded teeth 39 of two or more of the six forward straight oblique pitches disposed about the threaded rod 31 cooperate with a tooth direction of up and down threaded teeth of an inner ring of a groove through hole of the threaded rod 31 and all distance size stroke of up and down pitches of the inner ring of the threaded sleeve 40 of the concave threaded teeth 46 of two or more of the six forward straight oblique pitches disposed about the threaded sleeve 40.

### Embodiment 3

It differs from Embodiment 2 in that: referring from FIG. 3 to FIG. 3-1 to FIG. 3-6, the first hinge blade 10 is disposed with the first blade 12 and the first shaft sleeve 11. The second hinge blade 20 comprises two separate second blades 22 fixed on the hinge blade fixed base 19 and the second shaft sleeve 21. The second shaft sleeve 21 is concave to define the groove platform 101, and a fourth bearing 95 is encompassed in and connected to the inner ring of the second shaft sleeve 21, horizontally disposed on the groove platform 101 of the second shaft sleeve 21, and disposed between the first shaft sleeve 11 and the second shaft sleeve. The fourth bearing 95 is configured to help to strengthen the first blade 12 of the first hinge blade 10 to be closed and opened more smoothly. The sensor 535 with the lead wire 538 of the 12 volt DC power supply door magnetic switch 555 and the magnet body 537 without the lead wire 538 of the door magnetic switch.

The threaded sleeve 40 is rotatably but not movably and slidably connected to the inner ring of the second shaft sleeve 21, the first shaft sleeve 11 is fixed on the part of the transmission rod 42 extending out of the second shaft sleeve 21. The upper part of the threaded sleeve 40 protrudes to define the transmission rod 42, and the transmission rod 42 is configured to rotatably pass through the first bearing 100, the groove platform 101, the fourth bearing 95, and then the first shaft sleeve 11, and the transmission rod 42 is correspondingly disposed in the first shaft sleeve 11, the first shaft sleeve 11 is fixed on the transmission rod 42 the fixed connection threaded rod 98. Therefore, the distance of the axial direction and the wheelbase of the fixed rod 30 configured to axially move and slide up and down relative to the threaded sleeve 40 is positioned and limited, the adjusting base 70 correspondingly cooperates with the size value of the straight oblique pitch of the convex threaded teeth 39 of two or more of the six reverse straight oblique pitches of the threaded rod 31 of the fixed rod 30 and correspondingly cooperates with the size value of the straight oblique pitch of the concave threaded teeth 46 of two or more of the six reverse straight oblique pitches of the threaded sleeve 40, and the distance of the axial direction and the wheelbase of the threaded rod 31 configured to axially move and slide up and down relative to the threaded sleeve 40 is preset and limited. At the same time, the first spring 91 from the cylinder front surface of the convex ring 32 of the fixed rod 30 to enable the elastic force energy storage of the first spring 91 to change and release, the cylinder front surface of the convex ring 32 can axially slides to downwardly compress the elastic force energy storage of the first spring 91, the elastic force energy storage of another end can strongly abut the gasket 86 disposed on the front plane of the cup body 56, a releasing strength of the elastic force energy storage of the first spring 91 is preset and limited, and the speed that the blades of the hinge blades rotate leftward to be automatically closed can be synchronically preset. The adjusting base 70 is adjusted to rotate to correspondingly cooperate with the plug, the 12 volt DC power supply electromagnet 80, the fixed connection threaded rod 700 of the electromagnet, and the cup bottom of the cup body 58. Therefore, the required distance between the 12 volt DC power supply electromagnet 80 and the electromagnet suction disk 90 is adjusted, and the 12 volt DC power supply electromagnet 80 and the electromagnet suction disk 90 are magnetically coupled together to be positioned in the cup body 58. At the same time, the adjusting base is configured to synchronously and correspondingly adjust the required preset positioning angle of the first blade 12 of the first hinge blade 10. At the same time, the adjusting base is configured to adjust the releasing strength of the elastic force energy storage of the first spring 91, so that the adjusting base is configured to synchronously and correspondingly adjust the speed that the first blade 12 of the first hinge blade 10 itself automatically rotates leftward to be close.

A 12 volt power supply wire of a power supply wire connector 198 of a 12 volt circuit board of a 12 volt DC power supply base 199 of a vehicle body, one end input of the circuit board of the DC power supply transformer 127 is a volt of 12 volt positive DC power supply and a volt booster conversion connector 105, so that the DC power supply transformer 127 is configured to enable the volt of 12 volt positive DC power supply and the volt booster conversion connector 105 of the one end input of the circuit board of the DC power supply transformer 127 to be converted into enable another end output of the circuit board to be converted 24 volt positive power supply wire and a volt booster conversion connector 102, a 24 volt positive DC power supply wire of a 24 volt DC power supply timing controller 225 is configure to be connected to the converted 24 volt positive power supply wire and the volt booster conversion connector 102 of the another end output of the DC power supply transformer 127. Further, the 12 volt power supply wire of the power supply wire connector 198 of the 12 volt circuit board of 12 volt DC power supply base 199 of the vehicle body is configured to be connected to a volt of 12 volt negative DC power supply and the volt booster conversion connector 105 of the one end input of the circuit board of the DC power supply transformer 127, so that the DC power supply transformer 127 is configured to enable the volt of 12 volt negative DC power supply and the volt booster conversion connector 105 of the one end input of the circuit board of the DC power supply transformer 127 to convert into the converted 24 volt negative power supply wire and the volt booster conversion connector 102 of the another end output of the circuit board, the 24 volt negative DC power supply wire of the 24 volt DC power supply timing controller 225 is configure to be connected to the converted 24 volt negative power supply wire and the volt booster conversion connector 102 of another end output of the DC power supply transformer 127, so that the 24 volt DC power supply timing controller 225 is configured to correspondingly cooperate with the DC power supply transformer 127. The 24 volt DC power supply wire of the 24 volt DC power supply timing controller 225 is configured to be connected to a 24 volt DC power supply wire of a 24 volt DC power supply electromagnet, so that the 24 volt DC power supply timing controller 225 functions by mobile phone remote control, voice control, wireless remote control, electronic intelligence control, or manual control of a button for an automatic positioning duration of the 24 volt DC power supply timing controller 225 that the hinge blades are automatically positioned at the preset positioning angle position, so that the duration that the 24 volt DC power supply electromagnet 80 is magnetically coupled to the electromagnet suction disk 90 each time is preset. At the same time, the 24 volt DC power supply timing controller 225 can also synchronically and correspondingly preset the automatic positioning duration of the first blade 12 of the first hinge blade 10 that is automatically positioned at the preset positioning angle position each time. Therefore, for example, a duration that the 24 volt DC power supply electromagnet 80 is magnetically coupled to the electromagnet suction disk 90 each time is configured to be preset from 1 second to any time within 24 hours by the 24 volt DC power supply timing controller 225 and is configured to be the duration that the 24 volt DC power supply electromagnet 80 is fixedly and magnetically coupled to the electromagnet suction disk 90 each time. At the same time, the 24 volt DC power supply timing controller 225 functions by mobile phone remote control, voice control, wireless remote control, electronic intelligence control, or manual control of the button for the automatic positioning duration of the 24 volt DC power supply timing controller 225 that the hinge blades are automatically positioned at the preset positioning angle position, and the first blade 12 of the first hinge blade 10 that is automatically positioned at the preset positioning angle position each time is synchronically and correspondingly preset. That the first blade 12 of the first hinge blade 10 is configured to be automatically positioned at the preset positioning angle position is configured to be synchronously preset. At the same time, a fixed automatic positioning duration is configured to be preset from 1 second to any time within 24 hours each time and is configured to be the duration that the first blade 12 of the first hinge blade 10 is automatically positioned at the preset positioning angle each time. Therefore, the duration that the 24 volt DC power supply electromagnet 80 is fixedly magnetically coupled to the electromagnet suction disk 90 each time is configured to be preset from 1 second to 8 seconds within 24 hours by the 24 volt DC power supply timing controller 225 and is configured to be 8 seconds that the 24 volt DC power supply electromagnet 80 is fixedly and magnetically coupled to the electromagnet suction disk 90 each time. It is also be 8 seconds that is preset by the 24 volt DC power supply timing controller 225. At the same time, the 24 volt DC power supply timing controller 225 is configured to correspondingly cooperate with to preset the first blade 12 of the first hinge blade 10 to be fixedly and automatically positioned at the preset positioning angle position each time and is fixedly and automatically positioned at the preset positioning angle position for 8 seconds. Therefore, the 24 volt DC power supply timing controller 225 is configured to preset using mobile phone remote control, voice control, wireless remote control, electronic intelligence control, or manual control of the preset button for the positioning duration of the 24 volt DC power supply timing controller 225 that the hinge blades are automatically positioned, so that the 24 volt DC power supply electromagnet 80 is fixedly and magnetically coupled to the electromagnet suction disk 90 each time, each time for the fixed and magnetic coupling is 8 seconds. At the same time, the 24 volt DC power supply timing controller 225 can also synchronously preset the first blade 12 of the first hinge blade 10 to be fixedly and automatically positioned at the preset positioning angle position each time, and the automatic positing duration is 8 seconds. When the first blade of the first hinge blade 10 reaches a fixed 8 second demagnetization time preset by the 24 volt DC power supply timing controller 225 that the 24 volt DC power supply electromagnet 80 is magnetically coupled to the electromagnet suction disk each time, an automatic 8 second duration preset by the 24 volt DC power supply timing controller 225 that the first blade of the first hinge blade 10 is automatically positioned at the preset positioning angle position reaches. At the same time, the first spring 91 is in the elastic force energy storage state of the first spring 91 compressed by the downward high pressure from the cylinder front surface of the convex ring 32 of the fixed rod 30 to enable the elastic force energy storage of the first spring 91 to change and release, so that the elastic force energy storage of the one end of the first spring 91 can strongly abut the convex ring 32, and the elastic force energy storage of the another end can strongly abut the gasket 86 disposed on the front plane of the cup body 56, so that the first blade 12 of the first hinge blade 10 itself can automatically rotate leftward to close the door hinge. The 24 volt DC power supply timing controller 225 is preset using mobile phone remote control, voice control, wireless remote control, electronic intelligence control, or manual control of the preset button of the 24 volt DC power supply timing controller 225, the 24 volt DC power supply timing controller 225 releases the fixed 8 second demagnetization time of each time preset by the 24 volt DC power supply timing controller 225 in advance at a first 7 second demagnetization time, a first 5 second demagnetization time, a first 3 second demagnetization time, etc. of the 24 volt DC power supply electromagnet 80, which can all be an advance demagnetization time of the 24 volt DC power supply electromagnet 80. At the same time, the 24 volt DC power supply timing controller 225 using pressing the 24 volt DC power supply timing controller 225 by the external force, mobile phone remote control, voice control, wireless remote control, electronic intelligence control, or manual control of the preset button for the positioning duration of the 24 volt DC power supply timing controller 225 that the hinge blades are automatically positioned at the preset positioning angle position, so that the 24 volt DC power supply timing controller 225 is configured to synchronously release the automatic positioning of the first blade 12 of the first hinge blade 10 preset by the 24 volt DC power supply timing controller 225 at the preset positioning angle, each fixed automatic positioning is first 7 second, first 5 second, first 3 second, etc. that are before 8 seconds, which can all be an advance automatic close time of leftward rotation of the first blade 12 of the first hinge blade 10. Therefore, after the first blade 12 of the first hinge blade 10 is configured to correspondingly cooperate with the 24 volt DC power supply electromagnet 80 in advance at the first 7 second demagnetization time, the first 5 second demagnetization time, the first 3 second demagnetization time, etc. that are before 8 seconds to all define the advance demagnetization time of the 24 volt DC power supply electromagnet 80. At the same time, the first spring 91 is in the elastic force energy storage state of the first spring 91 compressed by the downward high pressure from the cylinder front surface of the convex ring 32 of the fixed rod 30 to enable the elastic force energy storage of the first spring 91 to change and release, so that the elastic force energy storage of the one end of the first spring 91 can strongly abut the cylinder front surface of the convex ring 32, and the elastic force energy storage of the another end can strongly abut the gasket 86 disposed on the front plane of the cup body 56, so that the first blade 12 of the first hinge blade 10 itself can automatically rotate leftward to be closed before 8 seconds in advance. A wireless remote control 168 of the 24 volt DC power supply timing controller 225 is configured to press the button for automatic positioning duration of the wireless remote control 168 that the hinge blades are configured to be automatically positioned at the preset positioning angle position by the external force, the wireless remote control 168 is configured to remotely release the fixed 8 second demagnetization time preset by the 24 volt DC power supply timing controller 225 in advance at the first 7 second demagnetization time, the first 5 second demagnetization time, the first 3 second demagnetization time, etc. of the 24 volt DC power supply electromagnet 80, which can all be an advance demagnetization time of the 24 volt DC power supply electromagnet 80. At the same time, the wireless remote control 168 is configured to press the preset button for automatic positioning duration of the wireless remote control 168 that the hinge blades are configured to be automatically positioned at the preset positioning angle position by the external force. Therefore, the wireless remote control 168 is configured to synchronously release the automatic positioning of the first blade 12 of the first hinge blade 10 preset by the 24 volt DC power supply timing controller 225 at the preset positioning angle position, each fixed automatic positioning is first 7 second, first 5 second, first 3 second, etc. that are before 8 seconds, which can all be the advance automatic close time of leftward rotation of the first blade 12 of the first hinge blade 10 itself. After the first blade 12 of the first hinge blade 10 is configured to correspondingly cooperate with the 24 volt DC power supply electromagnet 80 in advance at the first 7 second demagnetization time, the first 5 second demagnetization time, the first 3 second demagnetization time, etc. that are before 8 seconds to define the advance demagnetization time of the 24 volt DC power supply electromagnet 80, so that the first blade 12 of the first hinge blade 10 itself is configured to rotate leftward to be automatically closed before 8 seconds in advance. The 24 volt DC power supply timing controller 225 is configure to cooperate with the wireless remote control 168, therefore, the wireless remote control 168 is configured to press the preset button for the automatic positioning duration of the wireless remote control 168 that the hinge blades are configured to be automatically positioned at the preset positioning angle position by the external force, the 24 volt DC power supply timing controller 225 is remotely controlled, the wireless remote control 168 is configured to preset the duration that the 24 volt DC power supply electromagnet 80 is fixedly and magnetically coupled with the electromagnet suction disk 90 each time. For example, the wireless remote control 168 for the automatic positioning duration that the hinge blades are configured to be automatically positioned at the preset positioning angle position is pressed each time, the automatic positioning duration that the hinge blades are automatically positioned at the preset positioning angle position is configured to be preset from 1 second to any time within 24 hours by the remote control and is configured to be the duration that the 24 volt DC power supply electromagnet 80 is magnetically coupled to the electromagnet suction disk 90. At the same time, the wireless remote control 168 is also synchronized the automatic duration that the blades of the hinge blades are configure to be automatically positioned at the preset automatic positioning angle by external force pressing, so that the automatic duration that the first blade 12 of the first hinge blade 10 is automatically positioned at the preset angle is remotely preset. For example, a time preset button of the wireless remote control 168 is pressed by external force each time to enable the wireless remote control 168 to preset the automatic duration of the blades of the hinge blades that is automatically positioned at a preset positioning angle position to be from one second to any time within more than 24 hours by remote control, which all can be preset to be the automatic positioning duration of the first blade 12 of the first hinge blade 10 by the remote control.

### Embodiment 4

The structure configured to preset the automatic positioning duration to enable the hinge blade to be automatically closed, for example, can be disposed in any door hinge blade and a shaft sleeve of a hinge blade of any door or window, for example, can be disposed in a shaft sleeve of a butterfly hinge, an H-shaped hinge, a son-and-mother shaped hinge, a flag-shaped hinge, and any particular hinge, etc. so that the hinge blade can be disposed in any door hinge blade, and a hinge blade of any door and window, etc., so that the hinge blade is configure to preset the automatic positioning duration to enable the hinge blade to be automatically closed.

It differs from Embodiment 3 in that, referring to FIG. 4 to FIG. 4-1 to FIG. 4-13, the second hinge blade 20 comprises the second shaft sleeve 21 and the second blade 22, and the second shaft sleeve 21 is disposed on a lower part of the second blade 22. The first hinge blade 10 comprises the first shaft sleeve 11 and the first blade 12, and the first shaft sleeve 11 is disposed on an upper part of the first blade 12. The fixed connection threaded rod 98 is screwed in and passes through the threaded rod through hole of the first shaft sleeve 11, locked in and passes through the swivel ring 41, and locked to and fixed on the transmission rod 42, so that the first shaft sleeve 11, the swivel ring 41, the transmission rod 42 are fixed together. The second flange 52 is disposed in the connecting sleeve 50, and the second flange 52 is configured to abut the inner side of the annular groove 520 of the plug 60 in the connecting sleeve 50. Therefore, the second flange 52 is embedded in the annular groove 520 of the plug 60 in the connecting sleeve 50, and the plug 60 and the second flange 52 are configured to be fixed in the connecting sleeve 50. The part of the plug 60 extending out of the connecting sleeve is screwed to and passes through the threaded rod through hole of the second shaft sleeve 21 by the fixed connection threaded rod 98, and locked in and fixed on the plug 60 to enable the second shaft sleeve 21 and the plug 60 to be fixed together.

The hinge further comprises the connecting sleeve 50, the fixed rod 30, the threaded sleeve 40, the first spring 91, the 24 volt DC power supply electromagnet 80, the electromagnet suction disk 90, a 220 volt AC power supply timing controller 125, a 220 volt AC power supply transformer 128 for converting into 12 volt DC power supply, the wireless remote control 168, the plug 60, and the adjusting base 70. The connecting sleeve 50 is connected to the inner side of the second shaft sleeve 21 and the inner side of the first shaft sleeve 11, the first shaft sleeve 11 and the second shaft sleeve 21 are arranged side to side up and down, so that the two hinge blades are configured to rotate relatively. The third bearing 300 is also rotatably encompasses the outer side of the connecting sleeve 50, the third bearing 300 is rotatably connected between a circumferential plane of one end of the second shaft sleeve 21 and a circumferential plane of one end of the first shaft sleeve 11, so that the first hinge blade 10 axially rotates more smoothly relative to the second hinge blade 20. One end of the first spring 91 encompasses the connection rod 311. One end of the first spring 91 is encompassed in the cap sleeve 92 to enable the one end of the first spring 91 to abut the convex ring 32, and another end of the first spring 91 abuts the gasket 86. The transmission rod 42 is rotatably and not movably connected to the inner side of the connecting sleeve 50, the connection comprises the swivel ring 41, and the swivel ring 41 is fixed on the part of the transmission rod 42 extending out of the connecting sleeve 50.

The tail end of the threaded rod 31 is fixed with the convex ring 32, the circumferential surface of the outer ring of the convex ring 32 is concave to define the convex ring sliding trail groove 332, the outer ring of the tail end of the convex ring 32 is concave to circumferentially define the annular mounting groove 321, the inner side of the annular mounting groove 321 is encompasses by the sealing rubber ring 322, the sealing rubber ring 322 further extends out of the annular mounting groove 321, so that the sealing rubber ring disposed in the annular mounting groove 321 of the convex ring 32 is configured to limit the threaded rod 31 disposed in the connecting sleeve 50 to axially move and slide up and down relative to the threaded sleeve 40 to generate a damping force and a resistance force, the sealing rubber ring disposed in the annular mounting groove 321 of the convex ring 32 is configured to limit a releasing strength of the elastic force energy storage of the first spring 91, and the sealing rubber ring disposed in the annular mounting groove 321 of the convex ring 32 is configured to limit a safe, damping, and automatic close of the first blade 12 of the first hinge blade 10 when being automatically closed.

The threaded sleeve 40 is rotatably and not movably connected to the inner side of the connecting sleeve 50, the first shaft sleeve 11, the swivel ring 41, and the transmission rod 42 are fixed together to position and limit the distance of the axial direction and the wheelbase of the fixed rod configured to axially move and slide up and down relative to the threaded sleeve. The swivel ring 41 and the first shaft sleeve 11 further limit and control an axial movement of the threaded sleeve 40. The second flange 52 is disposed in the connecting sleeve 50, the second flange 52 is configured to be embedded in the annular groove 520 of the plug 60 in the connecting sleeve 50, so that the plug 60 and the second flange 52 can be fixed in the connecting sleeve. The part of the plug 60 extending out of the connecting sleeve 50 is fixed on the second shaft sleeve 21, the plug 60, and the fixed adjusting base 70 by the fixed connection threaded rod 98. Preferably, the first flange 51 is disposed in the connecting sleeve 50, the first flange 51 is configured to be embedded in the annular groove 403 of the threaded ring 43 in the connecting sleeve 50, so that the first flange 51 is configured to be embedded in the annular groove 403 of the threaded ring in the connecting sleeve 50 and the threaded ring 43, the first flange 51, and the connecting sleeve 50 are fixed in the connecting sleeve 50 together. The threaded ring 43 is concave to define the through hole, the circumferential front edge of the inner ring of the through hole of the threaded ring 43 protrudes to define an inner ring flange 433 of the threaded ring. The fixed rod 30 comprises the convex ring, and the outer ring of the convex ring is concave to circumferentially define the convex ring sliding trail groove 332, the inner ring flange 433 of the threaded ring 43 is configured to abut the inner side of the convex ring sliding trail groove 332, the distance size of the axial direction and the wheelbase of the fixed rod configured to axially move and slide up and down relative to the threaded sleeve will not change. The third flange 53 is disposed in the connecting sleeve 50, the third flange 53 is configured to be embedded in the annular groove 530 of the first bearing in the connecting sleeve 50, the first bearing 44 and the third flange 53 are not configured to move relatively up and down and are connected to the inner side of the connecting sleeve 50 (the inner side of the connecting sleeve 50 is disposed with the third flange 53, so that the third flange is configured to be embedded in the annular groove 530 of the first bearing in the connecting sleeve 50 to limit the first bearing 44 from moving). The first spring 91 encompasses the connection rod 311, one end of the first spring 91 abuts the convex ring 32, and another end of the first spring 91 abuts the gasket 86. A distance of an axial direction and a wheelbase of an inner ring and an outer ring of the cup body 56 is disposed with a power supply wire through hole 561 of a side of the cup body 56, a distance of an axial direction and a wheelbase of an inner ring and an outer ring of the connecting sleeve 50 is disposed with a power supply wire through hole 567 of a side of the connecting sleeve 50, and a distance of an axial direction and a wheelbase of an inner ring and an outer ring of the second shaft sleeve 21 is disposed with a power supply wire through hole 568 of a side of the second shaft sleeve 21. Distances of the axial direction and the wheelbase of the inner ring and the outer ring of the power supply wire through hole 561 of the side of the cup body 56, the power supply wire through hole 567 of the side of the connecting sleeve 50, and the power supply wire through hole 568 of the side of the second shaft sleeve 21 are aligned and in communication. Therefore, the power supply wire of the 12 volt DC power supply electromagnet 80 can pass through the through hole 561, the through hole 567, and through hole 568 and is connected to the volt booster conversion connector 102 of another output end of the circuit board of the 220 volt AC power supply transformer 128 that is converted into the 12 volt DC power supply.

For example, the first blade 12 of the first hinge blade 10 needs to be automatically positioned in a 90 degree positioning angle position within the preset positioning angle, when the first blade 12 is opened to the required 90-degree preset positioning angle in a leftward rotation direction, the first blade 12 is configured to drive the transmission rod 42 and the threaded sleeve 40 to axially and downwardly slide to compress the elastic force energy storage of the first spring 91, and the threaded rod 31 is configured to axially and downwardly slide relative to the transmission rod 42 and the threaded sleeve 40. At the same time, the first spring 91 is the elastic force energy storage state of the first spring 91 compressed by a downward high pressure from the convex ring 32 of the fixed rod 30. At the same time, the threaded rod 31 of the fixed rod 30 and the electromagnet suction disk 90 correspondingly cooperates with the first blade 12 and is configured to move and slide downward to a preset positioning angle that the first blade 12 is opened to 90 degrees, and the first blade 12 is opened to a 90 degree positioning angle position of the required preset positioning angle. At the same time, the first blade 12 has no positioning function. At the same time, when the first blade 12 needs to be positioned at the 90 degree positioning angle position of the preset positioning angle by the adjusting base 70 disposed in the plug 60, the adjusting base 70 is adjusted to rotate to enable the adjusting base 70 to correspondingly cooperate with the plug, the 12 volt DC power supply electromagnet 80, the fixed connection threaded rod 700 of the electromagnet, and the cup bottom of the cup body 56. Therefore, the required distance between the 12 volt DC power supply electromagnet 80 and the electromagnet suction disk 90 is adjusted, and the 12 volt DC power supply electromagnet 80 and the electromagnet suction disk 90 are magnetically coupled together to be positioned in the cup body 58. At the same time, the adjusting base 70 is configured to synchronously and correspondingly adjust a required 90 degree preset positioning angle position of the first blade 12, so that the first blade 12 is configured to be automatically positioned at the 90 degree preset positioning angle within the preset positioning angle between 30 degrees to 180 degrees. However, after the first blade 12 is also opened to a 180 degree angle of a preset rotation maximum point of the first blade 12, at the same time, the first spring 91 is in the elastic force energy storage state of the first spring 91 compressed by a downward high pressure from the convex ring 32 of the fixed rod 30 to enable the elastic force energy storage of the first spring 91 to change and release. At the same time, the rubber column 59 is an elastic force energy storage state of the rubber column 59 compressed by a downward high pressure due to the convex ring 32 cooperating with the cap sleeve 92 of the first magnet to enable the elastic force energy storage of the rubber column 59 to change and to enable the elastic force energy storage of the rubber column 59 to release, so that the elastic force energy storage of one end of the rubber column 59 can strongly abut the convex ring 32, and the elastic force energy storage of the another end of the rubber column 59 can strongly abut the cap sleeve 92 of the electromagnet suction disk 90. Therefore, the first spring 91 and the rubber column 59 are configured to enable the first blade 12 to be backwardly closed, the first blade 12 rotates rightward to return to be automatically positioned at the 90 degree preset positioning angle position adjusted in place by the adjusting base 70 disposed in the plug 60. When the first blade 12 needs to be closed, the demagnetization time preset by the 12 volt DC power supply timing controller 125 that the 12 volt DC power supply electromagnet 80 is magnetically coupled to the electromagnet suction disk 90 each time. When a positioning time of the first blade 12 positioned at the positioning angle position reaches the automatic positioning time of the first blade preset by the 12 volt DC power supply timing controller 125, at the same time, the first spring 91 is in the elastic force energy storage state of the first spring 91 compressed by the downward high pressure from the convex ring 32 of the fixed rod 30 to enable the elastic force energy storage of the first spring 91 to change and release, so that the elastic force energy storage of the one end of the first spring 91 can strongly abut the cylinder front surface of the convex ring 32, and the elastic force energy storage of the another end can strongly abut the gasket 86 disposed on the front plane of the cup body 56, the first spring 91 is configured to enable the first blade 12 to rotate leftward to be closed backward, and the first blade 12 achieves an automatic leftward rotation close itself. The rubber column 59 can also be replaced by a non-ferrous metal spring of a non-ferrous metal elastic body.

One end input of the 220 volt AC power supply transformer 128 for converting into 12 volt DC power supply is a 220 volt AC power supply plug 158, a red wire of the 220 volt AC power supply plug 158 of the 220 volt AC power supply transformer 128 for converting into 12 volt DC power supply is an electronic live wire and is connected to a first input conversion connector 198 of 220 volt AC power supply of the transformer, and a blue wire of the 220 volt AC power supply plug 158 of the 220 volt AC power supply transformer 128 for converting into 12 volt DC power supply is a neutral wire and is connected to a second input conversion connector 198 of the 220 volt AC power supply of the transformer. The 220 volt AC power supply plug 158 configured to convert into 12 volt DC power supply is plugged in the 220 volt AC power supply socket 109. Another end output volt of the 220 volt AC power supply transformer 128 for converting into 12 volt DC power supply is a positive connector 102 converted into 12 volt DC power supply, another end output volt of the 220 volt AC power supply transformer 128 for converting into 12 volt DC power supply is a negative connector 102 converted into 12 volt DC power supply. A positive DC power supply connector 198 of the 12 volt DC power supply timing controller 125 is connected to a positive connector 102 converted into 12 volt DC power supply of another end output of the 220 volt AC power supply transformer 128 for converting into 12 volt DC power supply. A negative DC power supply connector 198 of the 12 volt DC power supply timing controller 125 is connected to a negative connector 102 converted into 12 volt DC power supply of another end output of the 220 volt AC power supply transformer 128 for converting into 12 volt DC power supply. A positive wire of the 12 volt DC power supply electromagnet 80 is connected to the positive connector 298 converted into 12 volt DC power supply of another end output volt of the 12 volt AC power supply timing controller 125. A negative wire of the 12 volt DC power supply electromagnet 80 is connected to one lead wire of the sensor 535 with the lead wire of the 12 volt DC power supply door magnetic switch 555, and another lead wire of the sensor 535 with the lead wire of the 12 volt DC power supply door magnetic switch 555 is connected to the negative connector 298 converted into 12 volt DC power supply of another end output volt of the 12 volt AC power supply timing controller 125. Therefore, the 12 volt DC power supply electromagnet 80 and the electromagnet suction disk 90 are configured to correspondingly cooperate with the 12 volt DC power supply timing controller 125 and the sensor 535 with the lead wire and the magnet body 537 of the 12 volt DC power supply door magnetic switch 555. The 12 volt DC power supply timing controller 125 functions by mobile phone remote control, voice control, wireless remote control, electronic intelligence control, or manual control of a preset button for an automatic positioning duration of the 12 volt DC power supply timing controller 125 that the hinge blades are automatically positioned at the preset positioning angle position, and a duration that the 24 volt DC power supply electromagnet 80 and the electromagnet suction disk 90 are fixedly and magnetically coupled with each time is preset. At the same time, the automatic positioning duration of the first blade 12 that is automatically positioned at the preset positioning angle position each time is also synchronically and correspondingly preset. For example, a duration that the 12 volt DC power supply electromagnet 80 is magnetically coupled to the electromagnet suction disk 90 each time is configured to be preset from 1 second to any time within 24 hours by the 12 volt DC power supply timing controller 125 and is all configured to be the duration that the 12 volt DC power supply electromagnet 80 is fixedly and magnetically coupled to the electromagnet suction disk 90 each time. At the same time, a duration that the first blade 12 is automatically positioned each time at the preset positioning angle position is configured to be preset from 1 second to any time within 24 hours by the 12 volt DC power supply timing controller 125 and is all configured to be the duration that the first blade 12 is automatically positioned at the preset positioning angle position each time. Therefore, the duration that the 12 volt DC power supply electromagnet 80 is magnetically coupled to the electromagnet suction disk 90 each time is fixedly configured to be preset from 1 second to 8 seconds within 24 hours by the 12 volt DC power supply timing controller 125 and is configured to be 8 seconds that the 12 volt DC power supply electromagnet 80 is fixedly and magnetically coupled to the electromagnet suction disk 90 each time. Therefore, the 12 volt DC power supply timing controller 125 functions by mobile phone remote control, voice control, wireless remote control, electronic intelligence control, or manual control of the preset button for the automatic positioning duration of the 12 volt DC power supply timing controller 125 that the hinge blades are automatically positioned at the preset positioning angle position, and the 8 seconds that the 12 volt DC power supply electromagnet 80 to be fixedly and magnetically coupled to the electromagnet suction disk 90 each time is preset. At the same time, the 12 volt DC power supply timing controller 125 can also synchronously preset the first blade 12 to be fixedly and automatically positioned at the preset positioning angle position each time, and the automatic positing duration is 8 seconds. When the first blade reaches a fixed 8 second demagnetization time preset by the 12 volt DC power supply timing controller 125 that the 12 volt DC power supply electromagnet 80 is magnetically coupled to the electromagnet suction disk each time, an automatic 8 second duration preset by the 12 volt DC power supply timing controller 125 that the first blade is automatically positioned at the preset positioning angle position each time reaches. At the same time, the first spring 91 is in the elastic force energy storage state of the first spring 91 compressed by the downward high pressure from the convex ring 32 of the fixed rod 30 to enable the elastic force energy storage of the first spring 91 to change and release, so that the first blade 12 itself can automatically rotate leftward to close the door hinge.

The 12 volt DC power supply timing controller 125 functions by mobile phone remote control, voice control, wireless remote control, electronic intelligence control, or manual control of the preset button for the automatic positioning duration of the 12 volt DC power supply timing controller 125 that the hinge blades are automatically positioned at the preset positioning angle position, and the 12 volt DC power supply timing controller 125 releases the fixed 8 second demagnetization time preset by the 12 volt DC power supply timing controller 125 that the 12 volt DC power supply electromagnet 80 and the electromagnet suction disk 90 are fixedly and magnetically coupled together each time in advance at a first 7 second demagnetization time, a first 5 second demagnetization time, a first 3 second demagnetization time, etc., which can all be an advance demagnetization time of the 12 volt DC power supply electromagnet 80. At the same time, the 12 volt DC power supply timing controller 125 functions by mobile phone remote control, voice control, wireless remote control, electronic intelligence control, or manual control of the preset button for the automatic positioning duration of the 12 volt DC power supply timing controller 125 that the hinge blades are automatically positioned at the preset positioning angle position, and the 12 volt DC power supply timing controller 125 releases the fixed 8 second duration preset by the 12 volt DC power supply timing controller 125 that the first blade 12 is automatically positioned at the preset positioning angle position, first 7 seconds, first 5 seconds, first 3 seconds, etc., which can all be an advance automatic close time of the first blade 12. The first blade 12 is configured to correspondingly cooperate with the 12 volt DC power supply electromagnet 80 in advance at the first 7 second demagnetization time, the first 5 second demagnetization time, the first 3 second demagnetization time, etc. that are before 8 seconds to define the advance demagnetization time of the 12 volt DC power supply electromagnet 80. At the same time, the first spring 91 is in the elastic force energy storage state of the first spring 91 compressed by the downward high pressure from the cylinder front surface of the convex ring 32 of the fixed rod 30 to enable the elastic force energy storage of the first spring 91 to change and release, so that the elastic force energy storage of the one end of the first spring 91 can strongly abut the convex ring 32, and the elastic force energy storage of the another end can strongly abut the gasket 86 disposed on the front plane of the cup body 56, the first blade 12 itself can automatically rotate leftward to be closed before 8 seconds in advance. A wireless remote control 168 of the 12 volt DC power supply timing controller 125 is configured to press the duration preset button for the automatic positioning duration of the wireless remote control 168 that the hinge blades are configured to be automatically positioned at the preset positioning angle position by the external force, the wireless remote control 168 is configured to remotely release the fixed 8 second demagnetization time preset by the 12 volt DC power supply timing controller 125 that the 12 volt DC power supply electromagnet 80 is magnetically coupled with the electromagnet in advance at the first 7 second demagnetization time, the first 5 second demagnetization time, the first 3 second demagnetization time, etc. which can all be an advance demagnetization time of the 12 volt DC power supply electromagnet 80. At the same time, the wireless remote control 168 is configured to press the preset button for the automatic positioning duration of the wireless remote control 168 by the external force that the hinge blades are configured to be automatically positioned at the preset positioning angle position. Therefore, the wireless remote control 168 is configured to synchronously release the automatic positioning of the first blade 12 preset by the 12 volt DC power supply timing controller 125 at the preset positioning angle, first 7 seconds, first 5 seconds, first 3 seconds etc. that are before 8 seconds fixed automatic positioning each time, which can all be the advance automatic close time of leftward rotation of the first blade 12 itself. Therefore, the first blade 12 is configured to correspondingly cooperate with the 12 volt DC power supply electromagnet 80 in advance at the first 7 second demagnetization time, the first 5 second demagnetization time, the first 3 second demagnetization time, etc. that are before 8 seconds to define the advance demagnetization time of the 8 seconds that the 12 volt DC power supply electromagnet 80 is magnetically coupled with the electromagnet suction disk 90. At the same time, the first spring 91 is in the elastic force energy storage state of the first spring 91 compressed by the downward high pressure from the cylinder front surface of the convex ring 32 of the fixed rod 30 to enable the elastic force energy storage of the first spring 91 to change and release, the first blade 12 of the first hinge blade 10 itself can automatically rotate leftward to be closed before 8 seconds in advance.

The magnet body 537 without the lead wire 538 of the first portion of the 12 volt DC power supply door magnetic switch 555 is also disposed on the door lock or the door blade and the assembly position is aligned and matched with the sensor 535 with the lead wire 538 of the 12 volt DC power supply door magnetic switch 555 of the doorframe, and the sensor 535 with the lead wire 538 of the second portion of the 12 volt DC power supply door magnetic switch 555 is also disposed on the door frame and the assembly position is aligned and matched with the magnet body 537 without the lead wire 538 of the 12 volt DC power supply door magnetic switch 555 disposed on the door lock or the door blade. One lead wire of the sensor 535 with the lead wire 538 of the 12 volt DC power supply door magnetic switch 555 is connected to the volt booster conversion connector 102 of another output end of the circuit board of the 220 volt AC power supply transformer 128 that is converted in the volt DC power supply, and another lead wire of the sensor 535 with the lead wire 538 of the 12 volt DC power supply door magnetic switch 555 is connected to the 12 volt DC power supply electromagnet 80. Another solution is alternative here that the sensor 535 with the lead wire 538 of the first portion of the 12 volt DC power supply door magnetic switch 555 is also disposed on the vehicle door lock or the vehicle door blade, and the magnet body 537 without the lead wire 538 of the second portion is also disposed on the vehicle door frame and the assembly position is aligned and matched with the sensor 535 with the lead wire 538 disposed on the door frame. When an electronic smart lock of the vehicle door lock or the vehicle door blade enables the electronic smart lock of the vehicle door lock or the vehicle door blade to be opened by electronic password intelligent sensor, a swipe sensor, a fingerprint sensor, or a conventional key, etc., and the door blade is opened to automatically positioned at the preset positioning angle position of the first blade 12 and the vehicle door blade. At the same time, the vehicle door blade drives the magnet body 537 without the lead wire 538 of the 12 volt DC power supply door magnetic switch 555 of the vehicle door lock or the vehicle door blade to be synchronously separated from the sensor 535 with the lead wire of the vehicle door frame. When the magnet body 537 without the lead wire of the 12 volt DC power supply door magnetic switch 555 of the vehicle door lock or the vehicle door blade is separated from the sensor 535 with the lead wire of the 12 volt DC power supply door magnetic switch 555 of the door frame by more than 10 mm, that is, the door blade is just opened a little clearance. At the same time, the 12 volt DC power supply timing controller 125 and the 12 volt DC power supply electromagnet 80 start power-on states. At the same time, 12 volt DC power supply timing controller 125 starts to open the duration that the 12 volt DC power supply electromagnet 80 is magnetically coupled to the electromagnet suction disk 90 each time. At the same time, the automatic positioning duration that the first blade 12 and the door frame are automatically positioned at the required preset positioning angle position is synchronized. When the first blade 12 reaches the demagnetization time that the 12 volt DC power supply electromagnet 80 is magnetically coupled to the electromagnet suction disk 90 each time, at the same time, the automatic positioning duration preset by the 12 volt DC power supply timing controller 125 that the first blade 12 is automatically positioned at the preset positioning angle position each time reaches, at the same time, the first spring 91 is in the elastic force energy storage state of the first spring 91 compressed by the downward high pressure from the convex ring 32 of the fixed rod 30 to enable the elastic force energy storage of the first spring 91 to change and release, so that the first blade 12 itself can automatically rotate to close the door blade. Further, the duration that the vehicle door blade is opened to the preset positioning angle position to be automatically positioned each time will repeat the positioning duration preset by the power supply timing controller that the vehicle door blade is configured to be automatically positioned at the required preset positioning angle position each time. When the magnet body without the lead wire of the 12 volt DC power supply door magnetic switch 555 of the vehicle door lock or the vehicle door blade is separated from the sensor with the lead wire of the 12 volt DC power supply door magnetic switch 555 of the door frame by more than 10 mm, the 12 volt DC power supply timing controller 125 and the 12 volt DC power supply electromagnet 80 start power-on states. When the magnet body without the lead wire of the 12 volt DC power supply door magnetic switch 555 of the vehicle door lock or the vehicle door blade is aligned and matched the sensor with the lead wire of the 12 volt DC power supply door magnetic switch 555 of the door frame, the 12 volt DC power supply timing controller 125 and the 12 volt DC power supply electromagnet 80 start power-off states.

The 12 volt DC power supply timing controller 125 is configured to correspondingly cooperate with the wireless remote control 168, so that the wireless remote control 168 enables a preset button of the wireless remote control 168 for the automatic positioning duration that the hinge blades can be automatically positioned at the preset positioning angle position to be pressed by manual force. Therefore, the automatic positioning duration preset by the 12 volt DC power supply timing controller 125 that the hinge blades are automatically positioned at the preset positioning angle position is remotely controlled, and the wireless remote control 168 is configured to preset the duration that the 12 volt DC power supply electromagnet 80 is magnetically coupled to the electromagnet suction disk 90. For example, the preset button for the automatic positioning duration that the hinge blades can be automatically positioned at the preset positioning angle position of the wireless remote control 168 is pressed, is configured to be remotely preset from 1 second to any time within 24 hours, and is configured to be the duration that the 12 volt DC power supply electromagnet 80 is fixedly and magnetically coupled to the electromagnet suction disk 90 each time. At the same time, the wireless remote control 168 is configured to synchronize the preset button of the wireless remote control 168 using manual force for the automatic positioning duration that the hinge blades can be automatically positioned at the preset positioning angle position to remotely preset the duration that the first blade 12 of the first hinge blade 10 is positioned at the preset positioning angle position each time. For example, the preset button of the wireless remote control 168 using external force for the automatic positioning duration that the hinge blades can be automatically positioned at the preset positioning angle position each time enables the wireless remote control 168 to remotely preset the automatic duration configured to be preset from 1 second to any time within 24 hours that the hinge blades are positioned at the preset positioning angle position, which are remotely preset to be the automatic positioning duration of the first blade.

A size value of a straight oblique pitch of the convex threaded teeth 39 of two or more of six reverse straight oblique pitches of the threaded rod 31 of the fixed rod 30 corresponds to the straight oblique pitch of the concave threaded teeth 46 of two or more of six reverse straight oblique pitches of the threaded sleeve 40 to preset the distance of the axial direction and the wheelbase that the treaded rod axially slides and moves up and down relative to the threaded sleeve. At the same time, the cylinder front surface of the convex ring 32 of the fixed rod 30 is configured to axially slides downward to compress the elastic force energy storage of the first spring 91, and the elastic force energy storage of another end can strongly abut the gasket 86 disposed on a front plane of the cup body 56 to limit the elastic force energy storage of the first spring 91 from releasing. Therefore, a speed that the blades of the hinge blades rotates leftward to be closed is preset and limited. The first blade 12 is pushed to be opened in a rightward rotation direction, the first blade 12 drives the transmission rod 42 and the threaded sleeve 40 to rotate, so that the threaded rod 31 is configured to axially slide downward to compress the elastic force energy storage of the spring relative to the threaded sleeve 40. At the same time, the six reverse straight oblique pitches 39 of the threaded rod 31 cooperate with and are screwed to six reverse straight oblique pitches 46 of the threaded sleeve 40, so that the six reverse straight oblique pitches 39 of the threaded rod 31 are configured to axially slide and move downward relative to six reverse straight oblique pitches 46 of the threaded sleeve 40, and the movement that the threaded rod 31 is configured to axially move up and down relative to the threaded sleeve 40 is within a rotation preset angle of the hinge blades. The electromagnetic force subjected to the fixed rod 30 by the 12 volt DC power supply electromagnet 80 and the electromagnet suction disk counteracts the abutting force converted by the elastic force energy storage of the first spring 91, so that the first blade 12 is configured to be automatically positioned within the rotatable preset positioning angle and is convenient for use. At the same time, the adjusting base is adjusted to rotate to cooperate with the plug, the 12 volt DC power supply electromagnet, the fixed connection threaded rod of the electromagnet, and the cup bottom of the cup body 56. Therefore, the required distance between the 12 volt DC power supply electromagnet and the electromagnet suction disk 90 is adjusted, and the 12 volt DC power supply electromagnet and the electromagnet suction disk 90 are magnetically coupled together to be positioned in the inner ring of the cup body 56. At the same time, the adjusting base is configured to synchronously and correspondingly adjust the hinge blades to be automatically positioned at the required preset positioning angle. The 12 volt DC power supply timing controller 125 enables the time preset button of the 12 volt DC power supply timing controller 125 to be pressed by manual force, so that the duration that the 12 volt DC power supply electromagnet 80 is magnetically coupled with the electromagnet suction disk 90 is preset. At the same time, the 12 volt DC power supply timing controller 125 is configured to synchronously preset the automatic positioning duration that the hinge blades are automatically positioned at the preset positioning angle to enable the hinge blades to be automatically positioned at the required preset positioning angle. When the first blade reaches the automatic positioning time of the first blade 12 preset by the 12 volt DC power supply timing controller 125, it is also the demagnetization time that the 12 volt DC power supply electromagnet 80 is magnetically coupled to the electromagnet suction disk 90, so that the 12 volt DC power supply electromagnet 80 is configured to correspondingly cooperate with the demagnetization time of the 12 volt DC power supply electromagnet 80 preset by the 12 volt DC power supply timing controller 125. At the same time, the first spring 91 is in an elastic force energy storage state of the first spring 91 compressed by a downward high pressure from the cylinder front surface of the convex ring 32 of the fixed rod 30 to enable the elastic force energy storage of the first spring 91 to change and release, so that the first blade of the first hinge blade itself can rotate leftward to be closed.

### Embodiment 5

The structure configured to preset the automatic positioning duration to enable the hinge blade to be automatically closed, for example, is suitable to be disposed in shaft sleeves of hinges of high hermetic flat doors and convex doors defining any shapes to enable the hinges of the high hermetic flat door and the convex doors to preset the automatic positioning duration to enable the hinge blade to be automatically closed are configured to be disposed on any of freezer door, refrigerator door, cold storage door, oven door, oven test equipment door, test box door, simulated environment test equipment door, mechanical equipment door, drying equipment door, soundproof door, special door, freshness-keeping warehouse door, tea-keeping warehouse door, civil engineering door, and a door page of any ship door, etc.

It differs from Embodiment 4 in that, referring to FIG. 5 to FIG. 5-1 to FIG. 5-3, the hinge comprises the first hinge blade 10, the fixed base 20, the fixed rod 30, the threaded sleeve 40, the threaded ring 43, the connecting sleeve 50, the 24 volt DC power supply electromagnet 80, the electromagnet suction disk 90, the 24 volt DC power supply timing controller 225, the 220 volt AC power supply transformer 128 for converting into 24 volt DC power supply, the wireless remote control 168, the plug 60, and the adjusting base 70. The first hinge blade 10 comprises the first shaft sleeve 11 and the first blade 12. The fixed base 20 comprises a fixed plate 25, a vertical bottom plate 22, and a protruding base 23 fixed on the vertical bottom plate 22. An end surface of the protruding base 23 of the vertical bottom plate 22 is concave to define the second shaft sleeve 21. The vertical bottom plate 22 is configured to define the second hinge blade 20, and the second hinge blade 20 is configured to define the second blade 22, and the fixed base 20 is configured to define second hinge blade 20. The connecting sleeve 50 is connected to inner sides of the first shaft sleeve 11 and the second shaft sleeve 21. The third bearing 300 is rotatably connected between the first shaft sleeve 11 and the second shaft sleeve 21 of the protruding base 23, the third bearing 300 is also rotatably connected to and encompasses the outer side of the connecting sleeve 50 to enable the first hinge blade 10 axially to rotate more smoothly relative to the fixed base 20. The first shaft sleeve 11 and the second shaft sleeve 21 of the protruding base 23 are arranged side to side to enable the first blade 12 of the first hinge blade 10 to rotate relative to the second shaft sleeve 21 of the protruding base 23. Therefore, the hinge is configured to the hinge structure of the high hermetic flat doors and the convex doors.

The threaded sleeve 40 is rotatably but not movably connected to the connecting sleeve 50 in the first shaft sleeve 11, the swivel ring 41 disposed in the first shaft sleeve 11 of the first hinge blade 10 and the transmission rod 42 of the threaded sleeve 40 extend out of the connecting sleeve 50, and the fixed connection comprises the swivel ring 41, the upper part of the threaded sleeve 40 protrudes to define the transmission rod 42, and the transmission rod 42 is configured to rotatably pass through the inner ring through hole of the first bearing 100 and then pass through the inner ring through hole of the swivel ring 41. The flat cutting edge of the side surface of the outer ring of the transmission rod 42 corresponds with the flat cutting edge of the inner ring of the inner ring through hole of the swivel ring 41, and the swivel ring 41 is correspondingly disposed on the upper part of the first shaft sleeve 11, the first shaft sleeve 11, the swivel ring 41, and the transmission rod 42 are fixed together due to that the fixed connection threaded rod 98 passes through and is screwed to the threaded rod through hole of the first shaft sleeve 11, passes through and is locked to the swivel ring 41, and then locked to and fixed on the transmission rod 42. Therefore, the swivel ring 41 and the first shaft sleeve 11 are further configured to limit the axial movement of the threaded sleeve 40 to preset the distance of the axial direction and the wheelbase that the fixed rod axially slides and moves up and down relative to the threaded sleeve to not change. When the two hinge blades rotate relative to each other, the threaded rod is further configured to axially slide and move up and down relative to the threaded sleeve within the preset rotation angle of the first blade 12 of the first hinge blade 10.

One end input of the 220 volt AC power supply transformer 128 for converting into 24 volt DC power supply is a 220 volt AC power supply plug 158, a red wire of the 220 volt AC power supply plug 158 of the 220 volt AC power supply transformer 128 for converting into 24 volt DC power supply is an electronic live wire and is connected to the first input conversion connector 198 of 220 volt AC power supply of the transformer, and a blue wire of the 220 volt AC power supply plug 158 for converting into 24 volt DC power supply is a neutral wire and is connected to the second input conversion connector 198 of the 220 volt AC power supply of the transformer. The 220 volt AC power supply plug 158 configured to convert into 24 volt DC power supply is plugged in the 220 volt AC power supply socket 109. Another end output volt of the 220 volt AC power supply transformer 128 for converting into 24 volt DC power supply is a positive connector 102 converted into 24 volt DC power supply, another end output volt of the 220 volt AC power supply transformer 128 for converting into 24 volt DC power supply is a negative connector 102 converted into 24 volt DC power supply. A positive DC power supply connector 198 of the 24 volt DC power supply timing controller 225 is connected to a positive connector 102 converted into 24 volt DC power supply of another end output of the 220 volt AC power supply transformer 128 for converting into 24 volt DC power supply. A negative DC power supply connector 198 of the 24 volt DC power supply timing controller 225 is connected to a negative connector 102 converted into 24 volt DC power supply of another end output of the 220 volt AC power supply transformer 128 for converting into 24 volt DC power supply. A positive wire of the 24 volt DC power supply electromagnet 80 is connected to the positive connector 298 converted into 24 volt DC power supply of another end output volt of the 24 volt DC power supply timing controller 225. A negative wire of the 24 volt DC power supply electromagnet 80 is connected to one lead wire of the sensor 535 with the lead wire of a door magnetic switch 555, and another lead wire of the sensor 535 with the lead wire of the door magnetic switch 555 is connected to the negative connector 298 converted into 24 volt DC power supply of another end output volt of the 24 volt DC power supply timing controller 225. Therefore, the 24 volt DC power supply electromagnet 80 and the electromagnet suction disk 90 are configured to correspondingly cooperate with the 24 volt DC power supply timing controller 225 and the sensor 535 with the lead wire and the magnet body 537 of the door magnetic switch 555. The 24 volt DC power supply timing controller 225 functions by mobile phone remote control, voice control, wireless remote control, electronic intelligence control, or manual control of a preset button for an automatic positioning duration of the 24 volt DC power supply timing controller 225 that the hinge blades are automatically positioned at the preset positioning angle position, and a duration that the 24 volt DC power supply electromagnet 80 and the electromagnet suction disk 90 are fixedly and magnetically coupled with each time is preset. At the same time, the automatic positioning duration of the first blade 12 of the first hinge blade 10 that is automatically positioned at the preset positioning angle position each time is also synchronically and correspondingly preset. For example, a duration that the 24 volt DC power supply electromagnet 80 is magnetically coupled to the electromagnet suction disk 90 each time is configured to be preset from 1 second to any time within 24 hours by the 24 volt DC power supply timing controller 225 and is all configured to be the duration that the 24 volt DC power supply electromagnet 80 is fixedly and magnetically coupled to the electromagnet suction disk 90 each time. At the same time, a duration that the first blade 12 is automatically positioned each time at the preset positioning angle position is configured to be preset from 1 second to any time within 24 hours by the 24 volt DC power supply timing controller 225 and is all configured to be the duration that the first blade 12 is automatically positioned at the preset positioning angle position each time. Therefore, the duration that the 24 volt DC power supply electromagnet 80 is magnetically coupled to the electromagnet suction disk 90 each time is fixedly configured to be preset from 1 second to 8 seconds within 24 hours by the 24 volt DC power supply timing controller 425 and is configured to be 8 seconds that the 24 volt DC power supply electromagnet 80 is fixedly and magnetically coupled to the electromagnet suction disk 90 each time. Therefore, the 24 volt DC power supply timing controller 225 functions by mobile phone remote control, voice control, wireless remote control, electronic intelligence control, or manual control of the preset button for the automatic positioning duration of the 24 volt DC power supply timing controller 225 that the hinge blades are automatically positioned at the preset positioning angle position, and the 8 seconds that the 24 volt DC power supply electromagnet 80 to be fixedly and magnetically coupled to the electromagnet suction disk 90 each time is preset. At the same time, the 24 volt DC power supply timing controller 225 can also synchronously preset the first blade 12 of the first hinge blade 10 to be fixedly and automatically positioned at the preset positioning angle position each time, and the automatic positing duration is 8 seconds. When the first blade reaches a fixed 8 second demagnetization time preset by the 24 volt DC power supply timing controller 225 that the 24 volt DC power supply electromagnet 80 is magnetically coupled to the electromagnet suction disk each time, an automatic 8 second duration preset by the 24 volt DC power supply timing controller 225 that the first blade 12 of the first hinge blade 10 is automatically positioned at the preset positioning angle position each time reaches. At the same time, the first spring 91 is in the elastic force energy storage state of the first spring 91 compressed by the downward high pressure from the convex ring 32 of the fixed rod 30 to enable the elastic force energy storage of the first spring 91 to change and release, so that the elastic force energy storage of the one end of the first spring 91 can strongly abut the cylinder front surface of the convex ring 32, and the elastic force energy storage of the another end can strongly abut the gasket 86 disposed on the front plane of the cup body 56, the first blade 12 of the first hinge blade 10 itself can automatically rotate leftward to close the door hinge

The aforementioned embodiments are merely some embodiments of the present disclosure, and the scope of the disclosure is not limited thereto. Thus, it is intended that the present disclosure cover any modifications and variations of the presently presented scope and specification.

### INDUSTRIAL APPLICABILITY

A structure configured to preset an automatic positioning duration to enable hinge blades to be automatically closed of the present disclosure. When the hinge blades reach the automatic positioning time preset by the 12 volt DC power supply timing controller, so that the hinge blades synchronously cooperates with the demagnetization time point preset by the 12 volt DC power timing controller. At the same time, the elastic force energy storage of the first spring changes and releases. An application of the present disclosure is wide, and has good industrial applicability.

1. A structure configured to preset an automatic positioning duration to enable hinge blades to be automatically closed, comprising:
two hinge blades,
a threaded sleeve,
a fixed rod,
a first spring,
an electromagnet suction disk,
a power supply electromagnet,
a power supply timing controller,
a plug, and
an adjusting base, wherein:
the two hinge blades are configured to rotate relative to each other,
each of the two hinge blades comprises a shaft sleeve and a blade fixed on an outer side of the shaft sleeve,
the fixed rod comprises a threaded rod,
the threaded sleeve comprises a transmission rod,
the transmission rod is fixed in the shaft sleeve of the two hinge blades,
the plug is fixedly disposed in the shaft sleeve of the two hinge blades,
the threaded sleeve is separated from the plug,
the fixed rod, the first spring, the electromagnet suction disk, the power supply electromagnet, a bearing, and the adjusting base are disposed between the threaded sleeve and the plug disposed in the shaft sleeve of the two hinge blades,
the fixed rod cooperates with and is screwed to the threaded sleeve,
the adjusting base is adjusted to rotate to adjust a required distance between the power supply electromagnet and the electromagnet suction disk to enable the power supply electromagnet and the electromagnet suction disk to be positioned on an inner ring of a cup body,
the adjusting base is configured to synchronously and correspondingly cooperate to adjust the two hinge blades to be automatically positioned at a required preset positioning angle position,
one end of the power supply timing controller is connected to a power supply wire connector of a power supply base,
another end of the power supply timing controller is connected to a power supply wire connector of the power supply electromagnet,
the power supply timing controller functions by mobile phone remote control, voice control, wireless remote control, electronic intelligence control, or manual control of a preset button for an automatic positioning duration of the power supply timing controller by which the two hinge blades are automatically positioned at the required preset positioning angle position,
a duration by which the power supply electromagnet is magnetically coupled to the electromagnet suction disk each time is preset,
the power supply timing controller synchronously and correspondingly cooperates to preset an automatic positioning duration by which the two hinge blades are automatically positioned at the required preset positioning angle position each time to enable the two hinge blades to be automatically positioned at the required preset positioning angle position,
when the two hinge blades reach a demagnetization time preset by the power supply timing controller at which the power supply electromagnet is magnetically coupled to the electromagnet suction disk:
the two hinge blades are configured to synchronously and correspondingly cooperate with the demagnetization time of the power supply electromagnet,
an energy storage of the first spring changes and releases to enable an elastic force energy storage of one end of the first spring to abut a convex ring and another end of the first spring to abut a gasket of a front plane of the cup body,
the two hinge blades rotates to close a door blade.

2. The structure configured to preset the automatic positioning duration to enable the hinge blades to be automatically closed according to claim 1, wherein:
the power supply electromagnet is adjustably disposed in the cup body,
the electromagnet suction disk and the fixed rod are configured to move up and down and are disposed in the cup body,
the power supply electromagnet is configured to move relative to the plug, and
the power supply electromagnet and the electromagnet suction disk are magnetically coupled together to be positioned in the cup body.

3. The structure configured to preset the automatic positioning duration to enable the hinge blades to be automatically closed according to claim 1, wherein:
the blade of the shaft sleeve of a second hinge blade of the two hinge blades and the two hinge blades are fixed together,
a blade of a first hinge blade of the two hinge blades is fixed on an outer side of the shaft sleeve of the first hinge blade, and
the shaft sleeve of the first hinge blade is disposed on an upper part of the blade of the first hinge blade.

4. The structure configured to preset the automatic positioning duration to enable the hinge blades to be automatically closed according to claim 1, wherein:
a straight oblique pitch of convex threaded teeth of two or more reverse straight oblique pitches of the threaded rod of the fixed rod cooperates with and is screwed to a straight oblique pitch of concave threaded teeth of two or more reverse straight oblique pitches of the threaded rod of the fixed rod,
a distance of an axial direction and a wheelbase that the threaded rod axially moves and slides up and down relative to the threaded sleeve is preset.

5. The structure configured to preset the automatic positioning duration to enable the hinge blades to be automatically closed according to claim 3, comprising:
a DC power supply transformer, wherein:
a 12 volt positive DC power supply base of one end of a vehicle is a 12 volt positive DC power supply wire connector,
one input end of a circuit board of the DC power supply transformer defines the 12 volt positive DC power supply wire connector,
the DC power supply transformer enables the 12 volt positive DC power supply wire connector of the one input end of the circuit board of the DC power supply transformer to be changed into a 24 volt positive DC power supply wire connector of an output end of the circuit board that defines a circuit board of a converted 24 volt positive DC power supply,
a 12 volt positive DC power supply wire of a 24 volt DC power supply electromagnet is configured to be changed to the converted 24 volt positive DC power supply wire connector of the output end of the circuit board of the DC power supply transformer,
a 12 volt negative DC power supply base of another end of the vehicle is a 12 volt negative DC power supply wire connector,
a second input end of the circuit board of the DC power supply transformer defines the 12 volt negative DC power supply wire connector,
the DC power supply transformer enables the 12 volt negative DC power supply wire connector of the second input end of the circuit board of the DC power supply transformer to convert into a 24 volt negative DC power supply wire connector of a second output end of the circuit board that defines a circuit board of a converted 24 volt negative DC power supply, and
a 12 volt negative DC power supply wire of the 24 volt DC power supply electromagnet is configured to be connected to the converted 24 volt negative DC power supply wire connector of the second output end of the circuit board of the DC power supply transformer.

6. A structure configured to preset an automatic positioning duration to enable hinge blades to be automatically closed, comprising:
two hinge blades,
a connecting sleeve,
a threaded sleeve,
a fixed rod,
a first spring,
an electromagnet suction disk,
a 12 volt DC power supply electromagnet,
a 220 volt AC power supply transformer for converting a 12 volt DC power supply,
a 12 volt DC power supply timing controller,
a wireless remote control,
a plug, and
an adjusting base, wherein:
the two hinge blades are configured to rotate relative to each other,
each of the two hinge blades comprises a shaft sleeve and a blade fixed on an outer side of the shaft sleeve,
the fixed rod comprises a threaded rod,
the connecting sleeve is encompassed in the shaft sleeve of the two hinge blades,
the threaded sleeve is rotatably and not movably disposed in one end of the connecting sleeve,
the plug is fixedly disposed in another end of the connecting sleeve,
the threaded sleeve is separated from the plug,
the fixed rod, the first spring, the electromagnet suction disk, the 12 volt DC power supply electromagnet, a bearing, and the adjusting base are disposed between the threaded sleeve and the plug disposed in the connecting sleeve,
convex threaded teeth of two or more of six reverse straight oblique pitches of the threaded rod of the fixed rod cooperate with and are screwed to concave threaded teeth of two or more of six reverse straight oblique pitches of the threaded rod of the fixed rod,
the adjusting base is adjusted to rotate to cooperate with the plug, the fixed rod of the 12 volt DC power supply electromagnet, a cup bottom of a cup body, and the 12 volt DC power supply electromagnet and to adjust a required distance between the 12 volt DC power supply electromagnet and the electromagnet suction disk to enable the 12 volt DC power supply electromagnet and the electromagnet suction disk to be positioned on an inner ring of the cup body,
the adjusting base is configured to synchronously and correspondingly cooperate to adjust the two hinge blades to be automatically positioned at a required preset positioning angle position,
the converting comprising:
one end input of the 220 volt AC power supply transformer for converting into the 12 volt DC power supply is a 220 volt AC power supply plug,
a red wire of the 220 volt AC power supply plug for converting into the 12 volt DC power supply is an electronic live wire and is connected to a first input conversion connector of a 220 volt AC power supply of the 220 volt AC power supply transformer,
a blue wire of the 220 volt AC power supply plug for converting into the 12 volt DC power supply is a neutral wire and is connected to a second input conversion connector of the 220 volt AC power supply of the 220 volt AC power supply transformer,
the 220 volt AC power supply plug for converting into the 12 volt DC power supply is plugged in a 220 volt AC power supply socket,
a first output end of the 220 volt AC power supply transformer for changing into the 12 volt DC power supply is a positive connector converted into the 12 volt DC power supply,
a second output end of the 220 volt AC power supply transformer for changing into the 12 volt DC power supply is a negative connector converted into the 12 volt DC power supply,
a positive DC power supply connector of the 12 volt DC power supply timing controller is connected to the positive connector converted into the 12 volt DC power supply of the first output end of the 220 volt AC power supply transformer for converting into the 12 volt DC power supply,
a negative DC power supply connector of the 12 volt DC power supply timing controller is connected to a negative connector converted into the 12 volt DC power supply of the second output end of the 220 volt AC power supply transformer for converting into the 12 volt DC power supply,
a positive wire of the 12 volt DC power supply electromagnet is connected to the positive connector converted into the 12 volt DC power supply of a first output end of the 12 volt DC power supply timing controller,
a negative wire of the 12 volt DC power supply electromagnet is connected to one lead wire of a sensor with a lead wire of a door magnetic switch,
another lead wire of the sensor with the lead wire of the door magnetic switch is connected to the negative connector converted into the 12 volt DC power supply of a second output end of the 12 volt DC power supply timing controller,
the 12 volt DC power supply electromagnet and the electromagnet suction disk are configured to correspondingly cooperate with the 12 volt DC power supply timing controller and the sensor with the lead wire and a magnet body of the door magnetic switch,
the 12 volt DC power supply timing controller functions by mobile phone remote control, voice control, wireless remote control, electronic intelligence control, or manual control of a preset button for a hinge blade positioning duration of the 12 volt DC power supply timing controller,
a duration by which the 12 volt DC power supply electromagnet and the electromagnet suction disk are fixedly and magnetically coupled each time is preset to also correspondingly define the automatic positioning duration of the two hinge blades that is automatically positioned at the required preset positioning angle position each time, and
when the two hinge blades reaches an automatic positioning time of the two hinge blades preset by the 12 volt DC power supply timing controller to define a demagnetization time at which the 12 volt DC power supply electromagnet is magnetically coupled to the electromagnet suction disk:
the two hinge blades are configured to correspondingly cooperate with the demagnetization time preset by the 12 volt DC power supply timing controller at which the 12 volt DC power supply electromagnet is magnetically coupled with the electromagnet suction disk,
an elastic force energy storage of the first spring changes and releases,
the elastic force energy storage of one end of the first spring is configured to abut a convex ring, and
the elastic force energy storage of another end of the first spring abuts a gasket disposed on a front plane of the cup body, so that the two hinge blades themselves are configured to rotate to close a door blade.

7. The structure configured to preset the automatic positioning duration to enable the hinge blades to be automatically closed according to claim 6, wherein all distance size stroke of an up-and-down pitch of an outer ring of the threaded rod and a threaded tooth direction of the outer ring of the threaded rod disposed about convex threaded teeth of two or more straight oblique pitches of the fixed rod cooperates with all distance size stroke of an up-and-down pitch of an inner ring of the threaded sleeve and a threaded tooth direction of an inner ring of a groove hole disposed about concave threaded teeth of two or more straight oblique pitches of the threaded sleeve.

8. The structure configured to preset the automatic positioning duration to enable the hinge blades to be automatically closed according to claim 6, wherein:
the 12 volt DC power supply electromagnet is adjustably disposed in the cup body, and the electromagnet suction disk is configured to move up and down together with a connecting rod of the fixed rod and is disposed in the cup body.

9. The structure configured to preset the automatic positioning duration to enable the hinge blades to be automatically closed according to claim 6, wherein:
the magnet body without the lead wire of a first portion of the door magnetic switch is also configured to be disposed on a door lock or a door blade and an assembly position is aligned and matched with the sensor with the lead wire of the door magnetic switch,
the sensor with the lead wire of a second portion of the door magnetic switch is disposed on a vehicle door frame and an assembly position is aligned and matched with a magnet body of the door lock or the door blade,
a negative lead wire of the sensor with the lead wire of the door magnetic switch is connected to a negative DC power supply wire connector of the 12 volt DC power supply timing controller, and
a positive lead wire of the sensor with the lead wire of the door magnetic switch is connected to a positive wire of the 12 volt DC power supply electromagnet, or
the sensor with the lead wire of the first portion of the door magnetic switch is also disposed on the door lock or the door blade,
the magnet body without the lead wire of the second portion of the door magnetic switch is also disposed on the vehicle door frame and the assembly position is aligned and matched with the sensor with the lead wire of the door lock or the door blade,
when an electronic smart lock of the door lock and the door blade is enabled to be opened by an electronic password intelligent sensor, a swipe sensor, a fingerprint sensor, or a conventional key:
the door blade is opened to be automatically positioned at the preset positioning angle position of the two hinge blades and the door blade, and
at the same time, the door blade drives the magnet body without the lead wire of the door magnetic switch of the door lock and the door blade to be synchronously separated from the sensor with the lead wire of the vehicle door frame, and
when the magnet body without the lead wire of the door lock and the door blade is separated from the sensor with the lead wire of the vehicle door frame by more than 10 mm:
the door blade is opened with clearance,
at the same time, the 12 volt DC power supply timing controller starts a preset duration of the two hinge blades by which the 12 volt DC power supply electromagnet is magnetically coupled with the electromagnet suction disk each time,
at the same time, the 12 volt DC power supply electromagnet starts to open during the duration by which the 12 volt DC power supply electromagnet is magnetically coupled to the electromagnet suction disk each time and is preset by the 12 volt DC power supply timing controller, and
at the same time, the automatic positioning duration by which blades of the two hinge blades and the door blade are automatically positioned at the required preset positioning angle position each time is synchronized.

10. The structure configured to preset the automatic positioning duration to enable the hinge blades to be automatically closed according to claim 7, wherein:
the adjusting base is configured to be movably and adjustably disposed in the plug,
the adjusting base is screwed to and passes through the plug and abuts the cup bottom of the cup body,
a polished rod section of a fixed connection threaded rod of the 12 volt DC power supply electromagnet passes through a through hole of an inner ring of the adjusting base and then passes through a threaded rod through hole of the cup bottom of the cup body,
a threaded section of the fixed connection threaded rod of the 12 volt DC power supply electromagnet is screwed in and locked to a threaded tooth hole of the 12 volt DC power supply electromagnet,
a threaded rod head of the fixed connection threaded rod of the 12 volt DC power supply electromagnet abuts a step of the through hole of the inner ring of the adjusting base, so that the adjusting base, the fixed connection threaded rod of the 12 volt DC power supply electromagnet, and the 12 volt DC power supply electromagnet are connected together, and
the adjusting base is adjusted to rotate to adjust a distance between the 12 volt DC power supply electromagnet and the 12 volt DC power supply electromagnet.
